(19) United States
(12) Patent Application Publication
(10) Pub. No.: US 2022/0179164 A1
(43) Pub. Date: Jun. 9, 2022

(54) LENS BARREL AND CAMERA MODULE COMPRISING SAME

(71) Applicant: LG INNOTEK CO., LTD., Seoul (KR)

(72) Inventor: Dong Hyun Kim, Seoul (KR)

(21) Appl. No.: 17/593,935

(22) PCT Filed: Mar. 30, 2020
(86) PCT No.: PCT/KR2020/004299

§ 371 Date: Sep. 28, 2021

(30) Foreign Application Priority Data
Mar. 28, 2019 (KR) 10-2019-0035681

(51) Int. Cl. G02B 7/02; G02B 3/14

(52) U.S. Cl. CPC G02B 7/021; G02B 3/14

(57) ABSTRACT

An embodiment comprises: a first surface; a second surface disposed opposite the first surface; a side surface connecting the first surface and the second surface; a barrel part having an opening in which at least a part of a variable lens is disposed on the side surface; a first lens part disposed on the barrel part and disposed on one side of the variable lens; and a second lens part disposed on the barrel part and disposed on the other side of the variable lens, wherein the first surface of the barrel part has a stepped portion including a first area and a second area having a step difference from the first region.

### CROSS-REFERENCE TO RELATED APPLICATIONS

This application is the U.S. national stage application of International Patent Application No. PCT/KR2020/004299, filed Mar. 30, 2020, which claims the benefit under 35 U.S.C. § 119 of Korean Application No. 10-2019-0035681, filed Mar. 28, 2019, the disclosures of each of which are incorporated herein by reference in their entirety.

### TECHNICAL FIELD

Embodiments relate to a lens barrel and a camera module including the lens barrel.

### BACKGROUND ART

An optical device of a portable device may be required to exhibit high resolution capability, a small size, and various photographing functions. For example, the various photographing functions may mean at least one of a zoom-in/zoom-out function, an auto-focusing (AF) function, a handshaking correction function, and an optical image stabilization (OIS) function.

In order to realize the various photographing functions, technology for assembling a plurality of lenses with each other and directly moving the lens assembly may be used. However, when the number of lenses is increased, the size of the optical device may be increased.

The auto-focusing function and the handshaking correction function may be fulfilled by moving or tilting a plurality of lenses, which are fixed to a lens holder and are arranged in the optical-axis direction, in the direction of the optical axis or a direction perpendicular to the optical axis. To this end, there is need for an additional lens moving apparatus for driving a lens assembly composed of a plurality of lenses. However, because the lens moving apparatus requires a large amount of electric power and because an additional cover glass for protecting the lens assembly may further be provided in addition to a camera module, there is a problem in that the overall size of the camera module is increased. In order to solve this problem, a liquid lens unit, which is configured to perform an auto-focusing function and a handshaking correction function by electrically controlling the curvature of the interface between two kinds of liquids, has been researched.

### DISCLOSURE

### Technical Problem

Embodiments provide a lens barrel, and a camera module and an optical device each including the lens barrel, which are capable of allowing a large-sized liquid lens to be mounted thereon and of increasing the strength of a barrel unit without increasing the length thereof in the optical-axis direction.

The technical problem intended to be solved by the embodiments, are not limited to the above-mentioned technical problems, and other technical problems not mentioned above, will be clearly understood by one of ordinary skill in the art to which this invention belongs, from the following descriptions of embodiments.

### Technical Solution

A lens barrel according to an embodiment includes a barrel unit including a first surface, a second surface disposed opposite the first surface, a side surface connecting the first surface to the second surface, and an opening, which is formed in the side surface and in which at least a portion of a variable lens is disposed, a first lens unit, which is disposed at the barrel unit and at one side of the variable lens, and a second lens unit, which is disposed at the barrel unit and at another side of the variable lens, wherein the first surface of the barrel unit includes a first region and a second region having a portion that is stepped portion with respect to the first region.

The first region of the first surface may be connected to the side surface of the barrel unit, and the second region of the first surface may be positioned higher than the first region.

The barrel unit may include a first portion, at which the first lens unit is disposed and which projects from the second region of the barrel unit.

The barrel unit may include a second portion, at which the second lens unit is disposed and which projects from the second surface of the barrel unit.

The side surface of the barrel unit may include a first side surface and a second side surface, which face each other, and the opening may have a first opening formed in the first side surface, and a second opening formed in the second side surface.

The side surfaces of the barrel unit may include a third side surface and a fourth side surface, which connect the first side surface to the second side surface and face each other, and the stepped portion may include a first stepped portion and a second stepped portion, which are formed between the third side surface and the fourth side surface.

The stepped portion may include a third stepped portion and a fourth stepped portion, which are formed between the first side surface and the second side surface and connect the first stepped portion to the second stepped portion.

The width of the first region in a direction perpendicular to the third side surface may be less than the width of the first region in a direction perpendicular to the first side surface.

The first region of the barrel unit may be connected both to the third side surface and to the fourth side surface.

The first stepped portion may be parallel to the third side surface of the barrel unit, and the second stepped portion may be parallel to the fourth side surface of the barrel unit.

The barrel unit may include a projection projecting from at least one of the first side surface and the second side surface.

The projection may include a first projection formed at at least one of two sides of the first opening in the barrel unit, and a second projection formed at at least one of two sides of the second opening in the barrel unit.

The upper end of the projection may be positioned higher than the opening in the barrel unit, and the lower end of the projection may be positioned lower than the opening in the barrel unit.

A camera module according to an embodiment includes a circuit board, a lens holder disposed on the circuit board, a lens barrel coupled to the lens holder, a lens assembly including a first lens unit and a second lens unit, which are disposed in the lens barrel, and a variable lens disposed between the first lens unit and the second lens unit, wherein the lens barrel includes a side surface, which has therein an opening, in which at least a portion of the variable lens is disposed, and a projection formed at one side of the opening, and the lens holder has a groove, in which the projection of the lens barrel is disposed.

The lens barrel may include an upper surface, which is connected to the side surface and has a stepped portion, and the upper surface of the lens barrel may include a first region and a second region having a height difference in the optical-axis direction with respect to the first region.

The lens holder may include a column formed at a corner thereof, and the groove in the lens holder may be formed in the column.

### Advantageous Effects

Embodiments are capable of allowing a large-sized liquid lens to be mounted thereon without increasing the length in the optical-axis direction.

Furthermore, embodiments are capable of inhibiting a decrease in the strength of a barrel unit due to the increase in the size of a liquid lens, and further of increasing the strength of the barrel unit.

In addition, embodiments are capable of limiting rotation of a barrel unit and thus of inhibiting a collision of the barrel unit with a cover caused by rotation of the barrel unit during assembly of the barrel unit with a lens holder.

Furthermore, embodiments are capable of inhibiting deformation or breakage of a lens barrel caused by collision of a barrel unit with a cover.

The effects obtained by the embodiments are not limited to the above-mentioned effects, and other effects, which are not mentioned above, will be clearly understood by one of ordinary skill in the art to which this invention belongs from the following descriptions of embodiments.

### DESCRIPTION OF DRAWINGS

FIG. 1 is a perspective view of a camera module according to an embodiment;

FIG. 2 is an exploded perspective view of the camera module shown in FIG. 1;

FIG. 3A is a cross-sectional view of the camera module taken along line A-B in FIG. 1;

FIG. 3B is a cross-sectional view of the camera module taken along line C-D in FIG. 1;

FIG. 4A is an exploded perspective view of a liquid lens unit;

FIG. 4B is a bottom view of the liquid lens shown in FIG. 4A;

FIG. 5 is a top view of the liquid lens unit;

FIG. 6 is a bottom view of the liquid lens unit;

FIG. 7 illustrates a lens holder and an electric connection member;

FIG. 8 is a perspective view of the liquid lens unit received in a barrel unit, the electric connection member, and a lens holder;

FIG. 9 is a perspective view of the liquid lens unit received in the barrel unit and the electric connection member;

FIG. 10 is a perspective view of the barrel unit according to an embodiment;

FIG. 11A is a side view of the barrel unit shown in FIG. 10;

FIG. 11B is a cross-sectional view of the liquid lens unit and the barrel unit taken along line A-B in FIG. 10;

FIG. 11C is a cross-sectional view of the liquid lens unit and the barrel unit taken along line C-D in FIG. 10;

FIG. 12 is a plan view of the barrel unit;

FIG. 13 is a bottom view of the barrel unit;

FIG. 14 is a plan view of the barrel unit, the liquid lens unit, the electric connection member, and the lens holder shown in FIG. 8;

FIG. 15A is a perspective view of a barrel unit according to another embodiment, and FIG. 15B is a plan view of FIG. 15A;

FIG. 16 is a perspective view of a portable terminal according to an embodiment; and

FIG. 17 is a view illustrating the configuration of the portable terminal shown in FIG. 16.

### BEST MODE

Hereinafter, embodiments of the present invention will be described in detail with reference to the accompanying drawings.

The technical idea of the present invention may be embodied in many different forms, and should not be construed as being limited to the following embodiments set forth herein. One or more of components of the embodiments may be selectively combined with each other or replaced without departing from the technical spirit and scope of the present invention.

Unless otherwise particularly defined, terms (including technical and scientific terms) used in the embodiments of the present invention have the same meanings as those commonly understood by one of ordinary skill in the art to which this invention belongs. It will be further understood that commonly used terms, such as those defined in dictionaries, should be interpreted as having meanings consistent with their meanings in the context of the relevant art.

The terminology used in the embodiments of the present invention is for the purpose of describing particular embodiments only, and is not intended to limit the present invention. As used in the disclosure and the appended claims, the singular forms are intended to include the plural forms as well, unless the context clearly indicates otherwise. The phrase “at least one (or one or more) of A, B and C” may be interpreted as including one or more of all combinations of A, B and C.

Furthermore, when describing the components of the present invention, terms such as “first”, “second”, “A”, “B”, “(a)” or “(b)” may be used. Since these terms are provided merely for the purpose of distinguishing the components from each other, they do not limit the nature, sequence or order of the components.

It should be understood that, when an element is referred to as being “linked”, “coupled” or “connected” to another element, the element may be directly “linked”, “coupled” or “connected” to the another element, or may be “linked”, “coupled” or “connected” to the another element via a further element interposed therebetween. Furthermore, it will be understood that, when an element is referred to as being formed “on” or “under” another element, it can be directly “on” or “under” the other element, or can be indirectly disposed with regard thereto, with one or more intervening elements therebetween. In addition, it will also be understood that “on” or “under” the element may mean an upward direction or a downward direction based on the element.

Hereinafter, a lens moving apparatus, and a camera module and an optical device each including the lens moving apparatus will be described with reference to the accompanying drawings. For the convenience of description, although the camera module according to an embodiment is described using a rectangular coordinate system (x, y, z), the lens moving apparatus may be described using some other coordinate systems, and the embodiments are not limited thereto. In the respective drawings, the X-axis direction and the Y-axis direction mean directions perpendicular to an optical axis, i.e. the Z-axis. The Z-axis direction, which is the direction of the optical axis OA, may be referred to as a “first direction”, the X-axis direction may be referred to as a “second direction”, and the Y-axis direction may be referred to as a “third direction”. For example, the optical-axis direction may be a direction parallel to the optical axis OA.

The camera module according to an embodiment of the present invention is capable of performing an “auto-focusing function”. Here, the “auto-focusing function” serves to automatically focus an image of a subject on an image sensor surface.

In addition, the camera module according to the embodiment may perform a function of “handshake correction”. Here, the function of “handshake correction” may serve to inhibit the contour line of a captured image from being blurred due to vibration caused by shaking of the user's hand when capturing a still image.

Furthermore, the “terminal” may alternatively be referred to as a “pad”, an “electrode”, a “conductive layer”, or a “bonding portion”.

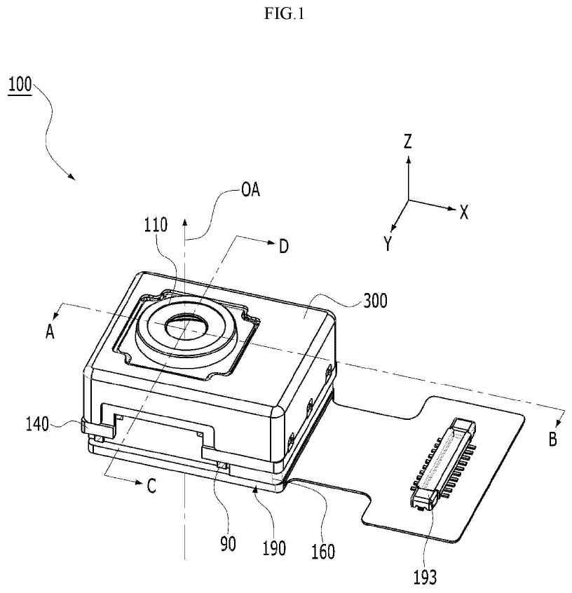

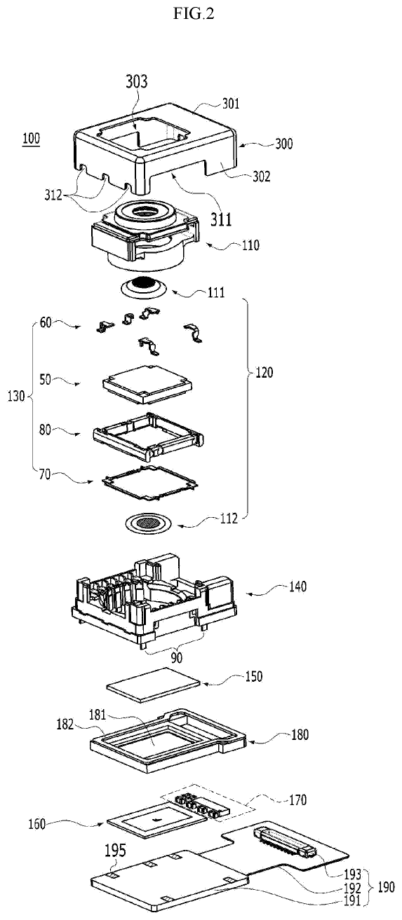

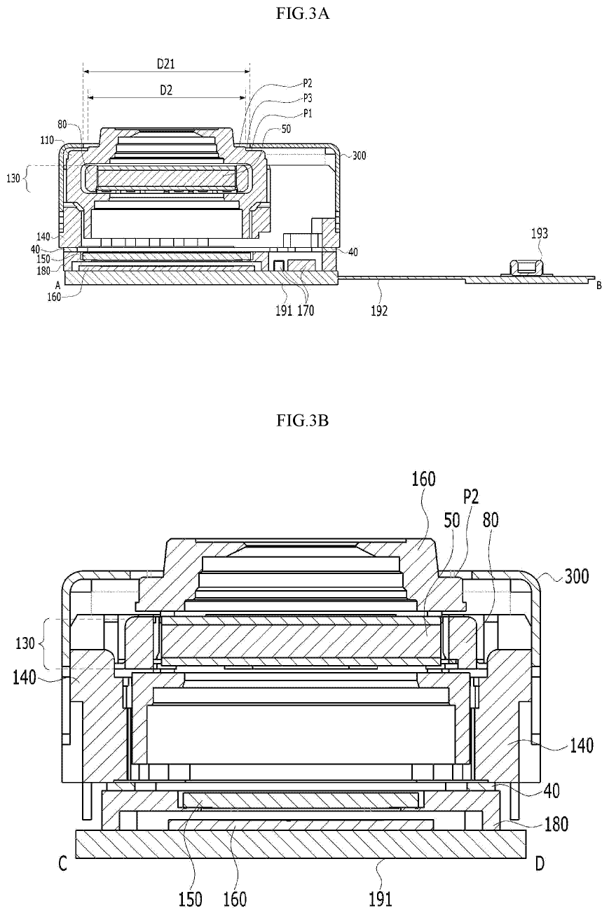

FIG. 1 is a perspective view of a camera module 100 according to an embodiment. FIG. 2 is an exploded perspective view of the camera module 100 shown in FIG. 1. FIG. 3A is a cross-sectional view of the camera module 100 taken along line A-B in FIG. 1. FIG. 3B is a cross-sectional view of the camera module 100 taken along line C-D in FIG. 1.

Referring to FIGS. 1 to 3B, the camera module 100 may include a barrel unit 110, a lens assembly 120 disposed or mounted to the barrel unit 110, and an image sensor 160 disposed under the barrel unit 110.

For example, although the lens barrel according to the embodiment may include the barrel unit 110 and the lens assembly 120, the disclosure is not limited thereto.

A lens barrel according to another embodiment may be the barrel unit 110 excluding the lens assembly 120. When the lens barrel corresponds to the barrel unit 110, the “barrel unit 110” may alternatively be referred to as a “lens barrel” in the following description.

The camera module 100 may further include a lens holder 140 configured to accommodate the barrel unit 110. The camera module 100 may further include a filter 150. The camera module 100 may further include a sensor base 180 to which the image sensor 160 is disposed or mounted.

The camera module 100 may further include a circuit board 190. The camera module 100 may further include a circuit element 170. The camera module 100 may further include a cover 300.

The circuit board 190 may be a printed circuit board (PCB).

The circuit board 190 may be disposed under the sensor base 180, and may include a first circuit board 191, a second circuit board 192 connected to the first circuit board 191, and a connector 193.

The camera module 100 may further include a circuit element 170 disposed or mounted to the first circuit board 191. Furthermore, the circuit board 190 may include at least one terminal 195, which is disposed or formed at the first circuit board 191. For example, the terminal 195 of the circuit board 190 may include a plurality of terminals, and the plurality of terminals 195 of the circuit board 190 may be conductively connected to an electric connection member 90.

The sensor base 180 and the image sensor 160 may be disposed at the first circuit board 191. The first circuit board 191 may be a rigid printed circuit board, and the second circuit board 192 may be conductively connected to the first circuit board 191, and may be a flexible printed circuit board, without being limited thereto. In another embodiment, the second circuit board 192 may be a rigid printed circuit board. In a further embodiment, the first circuit board 191 and the second circuit board 192 may integrally formed into a single integrated circuit board.

The image sensor 160 may be disposed at the circuit board 190. For example, the image sensor 160 may be disposed on the upper surface of the first circuit board 191, and may be conductively connected to the circuit board 190.

The optical axis of the image sensor 160 and the optical axis of the lens assembly may be aligned with each other. The image sensor 160 may include an effective image area (or an active area), and may convert the light radiated to the effective area (or the active area) into an electric signal.

The camera module 100 may further include the circuit element 170, which is disposed at the circuit board 190 (for example, the first circuit board 191), and the circuit element 170 may constitute a controller configured to control the image sensor 160 and a liquid lens unit 130.

The sensor base 180 may be disposed at the circuit board 190. For example, the sensor base 180 may be disposed on the upper surface of the first circuit board 191, and may be attached or coupled to the upper surface of the first circuit board 191. For example, the sensor base 180 may be disposed between the circuit board 190 and the lens holder 140.

The sensor base 180 may surround the image sensor 160 in order to protect the image sensor 160 from external contaminants and impacts, and may have therein a bore 181 through which the effective image area (or the active area) of the image sensor 160 is exposed.

The upper surface of the sensor base 180 may be provided with a seating portion 182 in which the filter 150 is seated. The seating portion 182 may have a height difference in the optical-axis direction with respect to the upper surface of the sensor base 180, and may be configured to surround the bore 181.

A portion of the lower surface of the sensor base 180 may be depressed so as to define a space or a seating groove (not shown), in which the image sensor 160 is disposed.

The sensor base 180 may be disposed at the first circuit board 191 so as not to overlap the circuit board 170 in the optical-axis direction and so as to be spaced apart from the circuit element 170. In another embodiment, the sensor base 180 may be omitted.

The filter 150 may be disposed at the sensor base 180. For example, the filter 150 may be disposed in the seating portion 182 in the sensor base 180, and may be positioned in the effective area (or the active area) of the image sensor 160.

The filter 150 may be disposed between the lens assembly 120 and the image sensor 160 so as to filter light within a specific wavelength range that passes through the lens assembly 120. For example, although the filter 150 may be an infrared (IR)-screening filter for blocking infrared radiation or a ultraviolet (UV)-screening filter for blocking ultraviolet radiation, the disclosure is not limited thereto.

The lens holder 140 may be disposed on the circuit board 190. For example, the lens holder 140 may be disposed on the sensor base 180. For example, the lower surface of the lens holder 140 may be coupled to the upper surface of the sensor base 180. The lens holder 140 may be disposed in the cover 300. The lens holder 140 may be made of an insulation material.

The lens holder 140 may be disposed between the liquid lens unit 130 and the circuit board 190 (for example, the first circuit board 191). The lens holder 140 may be provided with the electric connection member 90, through which drive signals (for example, drive voltages) supplied from the circuit board 190 are transmitted to the liquid lens unit 130 and a signal pertaining to temperature detection output from the liquid lens unit 130 is transmitted to the circuit board.

A first adhesive 40 may be disposed between the sensor base 180 and the lens holder 140 so as to couple the sensor base 180 to the lens holder 140.

For example, the first adhesive 40 may be disposed between the upper surface of the sensor base 180 and the lower surface of the lens holder 140. For example, the first adhesive 40 may be disposed between the side surface of the sensor base 180 and the lens holder 140. The first adhesive 40 may seal the gap between the sensor base 180 and the lens holder 140.

The camera module according to an embodiment may further include a second adhesive for bonding the barrel unit 110 to the lens holder 140 and a third adhesive for bonding the holder 80 of the liquid lens unit 130 to the lens holder 140, in addition to the first adhesive 40.

The lens assembly 120 may be mounted or disposed at the barrel unit 110.

The lens assembly 120 may include an optical unit.

For example, the lens assembly 120 may include the optical unit, a first lens unit 111, and a second lens unit 112.

Here, the optical unit may collect an input-light signal, which is reflected by a subject, through a single lens, and may transmit the signal to the image sensor 160.

For example, the optical unit may include a variable lens. The variable lens may be a convertible lens. Furthermore, the variable lens may be a lens having a focus capable of being controlled.

The variable lens may be at least one of a liquid lens, a polymer lens, a liquid crystal lens, a voice coil motor (VCM)-type lens, and a shape memory alloy (SMA)-type lens.

Here, the liquid lens may include a liquid lens including a single kind of liquid and a liquid lens including two kinds of liquids. The liquid lens including a single kind of liquid may change the focus by controlling a membrane disposed at a position corresponding to the liquid. For example, the liquid lens may change the focus by pressing the membrane using the electromagnetic force between a magnet and a coil. The liquid lens including two kinds of liquids may include a conductive liquid and a nonconductive liquid, and may control the interface defined between the conductive liquid and the nonconductive liquid using a voltage applied to the liquid lens.

Here, the polymer lens may change the focus of a high-molecular-weight material by means of a drive unit such as a piezo drive. The liquid crystal lens may change the focus by controlling a liquid crystal using electromagnetic force. The VCM-type lens may change the focus by controlling a solid lens or a lens assembly including a solid lens using the electromagnetic force between a magnet and a coil. An SMA-type lens may change the focus by controlling a solid lens or a lens assembly including a solid lens using a shape-memory alloy. The optical unit may include a filter, through which light within a specific wavelength range is transmitted. For example, the filter, through which light within a specific wavelength range is transmitted, may include an IR pass filter. Furthermore, the optical unit may include an optical plate. For example, the optical plate may be a light transmission plate.

The controller of the camera module or the controller of an optical device 200A may control the variable lens of the optical unit to shift an input light signal on the image sensor by a predetermined moving distance. The controller may shift the light path of an input light signal using the variable lens of the optical unit.

For example, the optical unit may include the liquid lens unit 130 including the liquid lens 50. For example, the lens assembly 120 may include the liquid lens unit 130, the first lens unit 111, and the second lens unit 112.

In the lens assembly 120, the first lens unit 1110 may alternatively be referred to as a “first solid lens unit”, and the second lens unit 112 may alternatively be referred to as a “second solid lens unit”.

In another embodiment, at least one of the second and third lens assemblies 111 and 112 of the lens assembly may be omitted. In a further embodiment, the lens assembly 120 may include the barrel unit 110 shown in FIG. 2.

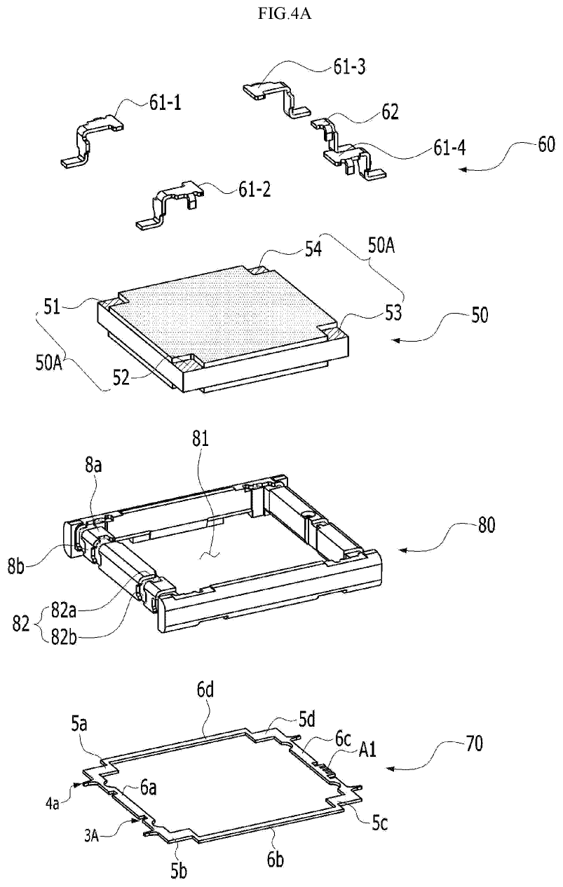

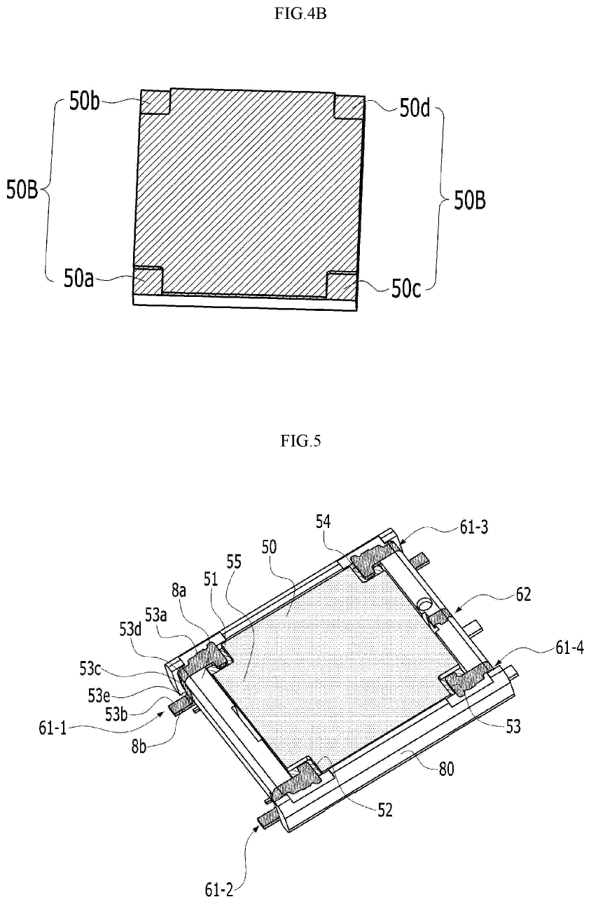

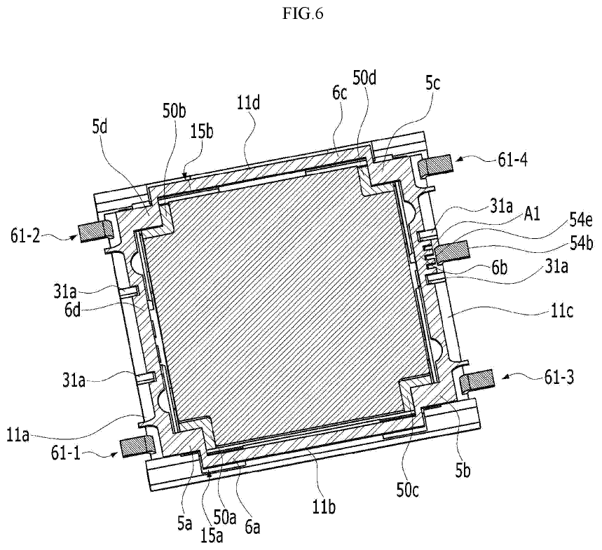

FIG. 4A is an exploded perspective view of the liquid lens unit 130. FIG. 4B is a bottom view of the liquid lens 50 shown in FIG. 4A. FIG. 5 is a top view of the liquid lens unit 130. FIG. 6 is a bottom view of the liquid lens unit 130.

Referring FIGS. 4A and 4B, the liquid lens unit 130 may include the liquid lens 50, an upper terminal 60, a lower terminal 70, and the holder 80. In another embodiment, the liquid lens unit may exclude at least one of the upper terminal 60, the lower terminal 70, and the holder 80.

The liquid lens 50 may be disposed between the lens of the first lens unit 111 and the lens of the second lens unit 112 so as to be spaced apart both from the lens of the first lens unit 111 and from the lens of the second lens unit 112 in the optical-axis direction.

The liquid lens 50 may include a liquid lens region including different kinds of liquids, an upper electrode 50A, and a lower electrode 50B. The liquid lens region may include a first conductive liquid and a second nonconductive liquid, and an interface may be formed between the first liquid and the second liquid.

The upper electrode 50A may alternatively be referred to as a “first electrode” or an “independent electrode”, and the lower electrode 50B may alternatively be referred to as a “second electrode” or a “common electrode”.

In order to deform the interface between the first liquid and the second liquid, the upper electrode 50A may include first to fourth upper electrodes 51 to 54, which are disposed at the periphery of the liquid lens.

The first to fourth upper electrodes 51 to 54 may be conductively isolated from one another, and respective drive signals may be supplied to the first to fourth upper electrodes 51 to 54.

The liquid lens 50 may be configured such that the interface defined between the conductive liquid and the nonconductive liquid is deformed by drive signals (for example, drive currents or drive voltages) or control signals, which are applied to the first to fourth upper electrodes 51 to 54 of the upper electrode 50A and the lower electrode 50B, and the focal length of the liquid lens may be adjusted by the deformed interface. Consequently, it is possible to perform at least one of an AF function and an OIS function of the lens assembly 120, and it is also possible to adjust the focal point of the camera module.

According to the embodiment, epoxy may be applied through the spaces between the liquid lens 50 and the solid lenses of the first and second lens units 111 and 112, and active alignment of the liquid lens 50 may be performed.

A portion of the liquid lens 50 may be provided with voltage from the upper electrode 50A. Another portion of the liquid lens 50 may be provided with voltage from the lower electrode 50B. The liquid lens 50 may be considered to be an equivalent circuit including four capacitors disposed between the four separate electrodes and the common electrode.

Here, each of the capacitors included in the equivalent circuit may have a capacitance as small as about 200 pF. In the embodiment, the upper electrodes 51 to 54 of the upper electrode 50A of the liquid lens 50 may be separate terminals, and the lower electrodes 50a to 50d of the lower electrode 50B may be conductively connected to each other so as to form a common terminal, without being limited thereto.

In another embodiment, the upper electrode 50A and the lower electrode 50B of the liquid lens 50 may be embodied so as to be reversely positioned.

For example, the upper electrode 50A may include the first to fourth upper electrodes 51 to 54, which are spaced apart from each other, and the first to fourth upper electrodes 51 to 54 may be separate terminals or separate electrodes.

For example, each of the first to fourth upper electrodes 51 to 54 may be formed or disposed at a corresponding one of the four corners of the upper surface of the liquid lens 50.

For example, the lower electrode 50B may include the lower electrodes 50a to 50d, which are formed at the four corners of the lower surface of the liquid lens 50, and the lower electrodes 50a to 50d may be connected to one another so as to form a common electrode or a common terminal.

Although the upper electrode 50A and the lower electrode 50B may be made of a conductive member, for example, a conductive metal, the disclosure is not limited thereto.

The holder 80 may receive or support the liquid lens 50, the upper terminal 60, and the lower terminal 70. The holder 80 may have therein a hole or a bore 81 configured to receive the liquid lens 50. For example, the hole 81 may be formed through the holder 80 in the optical-axis direction. The liquid lens 50 may be disposed or seated in the hole 81 in the holder 80.

The holder 80 may have a shape capable of being mounted to a first barrel portion of the barrel unit 110.

The holder 80 may have therein a groove 82, in which the upper terminal 60 is disposed or seated. For example, the holder 80 may have a plurality of grooves 82, and each of the plurality of grooves 82 may have the same shape as a corresponding one of terminals 61-1 to 61-4 and 62 of the upper terminal 60.

For example, the groove 82 may have a first groove 82a formed in the upper surface 8a of the holder 80. A portion of the upper terminal 60 may be disposed in the first groove 82a. The first groove 82a may be configured to have a shape corresponding to a portion of the upper terminal 60.

The groove 82 in the holder 80 may further have a second groove 82b formed in the side surface of the holder 80. For example, the second groove 82b may communicate with or be contiguous with the first groove 82a.

Another portion of the upper terminal 60 may be disposed in the second groove 82b. The second groove 82b may be configured to have a shape corresponding to the another portion of the upper terminal 60.

Referring to FIG. 5, the upper terminal 60 may be disposed at the holder 80. The upper terminal 60 may alternatively be referred to as an “upper connecting terminal (or first connecting terminal)”, an “upper connecting board (or first connecting board)”, or a “first terminal”.

At least a portion of the upper terminal 60 may be disposed on the side surface of the holder 80. For example, the at least a portion of the upper terminal 60 may be disposed in the groove 82 in the holder 80.

The upper terminal 60 may be conductively connected to the liquid lens 50.

For example, the upper terminal 60 may be conductively connected to at least one of the upper electrode 50A and the lower electrode 50B of the liquid lens 50.

For example, each of the four terminals 61-1 to 61-4 of the upper terminal 60 may be connected to a corresponding one of the first to fourth upper electrodes 51 to 54 of the liquid lens 50 via a conductive adhesive. One terminal 62 of the upper terminal 60 may be connected to the lower terminal 70 via a conductive adhesive.

For example, the conductive adhesive may include at least one of solder and a conductive adhesive (for example, conductive epoxy).

For example, each of the four terminals 61-1 to 61-4 of the upper terminal 60 may be conductively connected to a corresponding one of the upper electrodes 51 to 54 of the liquid lens 50. Furthermore, the terminal 62 of the upper terminal 60 may be conductively connected to the lower electrode 50B of the liquid lens 50 via the lower terminal 70.

The upper terminal 60 may project from the side surface 8b of the holder 80. The upper terminal 60 may be spaced apart from the electric connection member 90.

The upper terminal 60 may be connected at one end thereof to the upper electrode 50A of the liquid lens 50 and at the other end thereof to a conductive adhesive 75. Here, the other end of the upper terminal 60 may be disposed so as to be embedded in the conductive adhesive 75.

The other end of the upper terminal 60 may project from the holder 80. The other end of the upper terminal 60 may be spaced apart from the electric connection member 90 so as to overlap the electric connection member 90 in a vertical direction or in the optical-axis direction. The vertical direction may be parallel to the optical-axis direction.

The upper terminal 60 may include the plurality of terminals 61-1 to 61-4 and 62.

For example, two terminals 61-1 and 61-2 may be disposed on a first side surface of the liquid lens unit 130, and the other three terminals 61-3, 61-4 and 62 may be disposed on a second side surface of the liquid lens unit 130 opposite the first side surface of the liquid lens unit 130.

For example, the two terminals 61-1 and 61-2 may be disposed at one side of the holder 80, and the other three terminals 61-3, 61-4 and 62 may be disposed at the other side of the holder 80.

Here, the electric connection member 90 may include a plurality of electric connection portions 91-1 to 91-4. For example, each of the four electric connection portions 91-1 to 91-4 may be coupled to a corresponding one of the terminals 61-1 to 61-4 and 62 of the upper terminal 60 via the conductive adhesive 75, and may be conductively connected thereto.

For example, one conductive portion 92 may be coupled to the lower terminal 70 via an adhesive, and may be conductively connected thereto.

Each of the plurality of terminals 61-1 to 61-4 and 62 of the upper terminal 60 may include a first portion (a first coupler), which is disposed at the holder 80, and a second portion (a second coupler), which extends outwards from the first portion. For example, the first coupler and the second coupler may be connected to each other, and a curved or bent portion may be provided between the first coupler and the second coupler.

Each of the terminals 61-1 to 61-4 of the upper terminal 60 may include a first portion (or a first coupler) 53a, which is connected to a corresponding one of the first to fourth upper electrodes 51 to 54, a second portion (or a second coupler) 53b, which is connected to a corresponding one of the first to fourth electric connection portions 91-1 to 91-4 of the electric connection member 90, and a third portion (or a connector) 53c connecting the first portion 53a to the second portion 53b.

The second portion 53b may be coupled to the conductive adhesive 75.

The first portion 53a may be disposed on the upper surface of the holder 80, and may extend to a corresponding one of the upper electrodes 51 to 54 of the liquid lens 50.

At least a portion of the first portion 53a may overlap a corresponding one of the upper electrodes 51 to 54 of the liquid lens 50 in the optical-axis direction. For example, at least a portion of the first portion 53a of each of the first to fourth terminals 61-1 to 61-4 may overlap a corresponding one of the upper electrodes 51 to 54 of the liquid lens 50 in the optical-axis direction.

The third portion 53c may be disposed on the side surface of the holder 80, and may be connected at one end thereof to one end of the first portion 53a and at the other end thereof to one end of the second portion 53b.

Each of the first to fourth terminals 61-1 to 61-4 may further include a first bent portion 53d, which connects one end of the first portion 53a to one end of the third portion 53c and is bent toward the side surface 8b of the holder 80 from the upper surface 8a of the holder 80.

Furthermore, each of the first to fourth terminals 61-1 to 61-4 may further include a second bent portion 53e, which connects the other end of the third portion 53c to one end of the second portion 53b and is bent outwards from the side surface 8b of the holder 80.

The second portion 53b may project from the side surface 8b of the holder 80.

For example, the third portion 53 may define a right angle with respect to the first portion 53a and the second portion 53b.

The terminal 62 of the upper terminal 60 may include a first portion, which is disposed on the upper surface 8a of the holder 80, a second portion projecting from the side surface 8b of the holder 80, and a third portion, which is disposed on the side surface 8b of the holder 80 and connects the first portion 54a to the second portion 54b.

For example, the third portion of the terminal 62 may be connected to the electric connection portions 92 of the electric connection member 90 via the conductive adhesive 75.

The terminal 62 of the upper terminal 60 may further include a first bent portion, which connects one end of the first portion to one end of the third portion and is bent toward the side surface 8b of the holder 80 from the upper surface 8a of the holder 80, and a second bent portion, which connects the other end of the third portion to one end of the second portion and is bent outwards from the side surface 8b of the holder 80.

The lower terminal 70 may be disposed under the holder 80. For example, the lower terminal 70 may be disposed on the lower surface of the holder 80. The lower terminal 70 may alternatively be referred to as a “lower connecting terminal (or second connecting terminal)”, a “lower connecting board (or second connecting board)”, a “common electrode terminal”, or a “second terminal”.

The lower terminal 70 may be connected to the lower electrode 50B.

Referring to FIGS. 4A and 6, the lower terminal 70 may include first portions 5a to 5d, which are connected to the lower electrode 50B of the liquid lens 50, and second portions 6a to 6d, which are connected to the first portions 5a to 5d.

For example, the lower terminal 70 may include the first portions 5a to 5d, which are connected to the lower electrodes 50a to 50d, and the second portions 6a to 6d, each of which connects two adjacent first portions.

The first portions 5a to 5d may alternatively be referred to as “couplers” or “coupling regions”, and the second portions 6a to 6d may alternatively be referred to as “connectors” or “connecting regions”.

For example, the first portions 5a to 5d may be disposed in the corners or corner areas of the lower surface of the holder 80.

For example, the second portions 6a to 6d may be disposed at first to fourth sides 11a to 11d of the lower surface of the holder 80, each of which is positioned between two adjacent corners or corner areas of the lower surface of the holder 80. Alternatively, the second portions 6a to 6d may be disposed adjacent to the edges (or sides) of the lower surface of the holder 80, each of which is positioned between two adjacent corners or corner areas of the lower surface of the holder 80.

The first portions 5a to 5d of the lower terminal 70 may include first regions, which extend toward the lower electrodes 50a to 50d and overlap the lower electrodes 50a to 50d in the optical-axis direction. Furthermore, the first portions 5a to 5d of the lower terminal 70 may include second regions, which connect the first regions of the first portions 5a to 5d of the lower terminal 70 to the second portions 6a to 6d of the lower terminal 70. For example, the first portions 5a to 5d of the lower terminal 70 may be configured to be bent toward the second portions 6a to 6d from the first regions of the first portions 5a to 5d of the lower terminal 70.

For example, each of the second regions of the first portions 5a to 5d of the lower terminal 70 may extend toward a corresponding one of the first to fourth sides 11a of the lower surface of the holder 80.

The lower surface of the holder 80 may have therein grooves 15a and 15b, in which at least portions of the second portions 6a to 6d of the lower terminal 70 are disposed.

For example, the lower surface of the holder 80 may include a first surface, on which the second portions 6a to 6d of the lower terminal 70 are disposed, and a second surface corresponding to the corners of the lower surface of the holder 80. The first surface of the lower surface of the holder 80 may have a height difference with respect to the second surface of the lower surface of the holder 80 in the optical-axis direction. For example, the height of the second surface of the lower surface of the holder 80 may be lower than the height of the first surface of the lower surface of the holder 80. For example, the corners of the lower surface of the holder 80 may project from the first surface of the lower surface of the holder 80.

For example, an adhesive may be disposed between the lower terminal 70 and the holder 80 so as to couple the lower terminal 70 to the holder 80.

Because the lower terminal 70 is disposed in the groove, it is possible to suppress or inhibit the rotation of the lower terminal 70 when the lower terminal 70 is coupled to the holder 80 or to the lower electrode 50B.

Referring to FIG. 6, a portion of the terminal 62 of the upper terminal 60 may be coupled to at least a portion of the second portions 6a to 6d of the lower terminal 70 via a conductive adhesive.

For example, at least one of the second portion 54b and the bent portion 54e of the terminal 62 of the upper terminal 60 may be coupled to a region of one 6b among the second portions 6a to 6d of the lower terminal 70 via a conductive adhesive.

In order to increase the contact area with the conductive adhesive, a region of one (for example, 6b) among the second portions 6a to 6d of the lower terminal 70 may be provided with an uneven portion A1 so as to increase the coupling force between the terminal 62 of the upper terminal 60 and a region of one (for example, 6b) among the second portions 6a to 6d of the lower terminal 70. Here, the convex portion and the concave portion of the uneven portion A1 may be formed so as to face the second portion 54b and/or the second bent portion 54e of the terminal 62 of the upper terminal 60.

In another embodiment, others among the second portions 6a to 6d of the lower terminal 70 may also be provided with uneven portions so as to increase the contact area with an adhesive to thus increase the coupling force between the lower terminal 70 and the holder 80. For example, the uneven portions, which are formed at the others among the second portions 6a to 6d of the lower terminal 70, may be positioned opposite each other, without being limited thereto.

Referring to FIGS. 4A and 6, each of the second side of the lower surface of the holder 80 and the fourth side of the lower surface of the holder 80, which is positioned opposite the first side, may be provided with at least one protrusion 31a. For example, the protrusion 31a may project from the first surface of the lower surface of the holder 80.

The lower terminal 70 may have therein a groove 3A, which is formed at a position corresponding to the protrusion 31a formed on the lower surface of the holder 80. Although, in an example, the groove 3A in the lower terminal 70 is formed in the second portion 6a or 6c of the lower terminal 70, the disclosure is not limited thereto.

The protrusion 31a formed on the lower surface of the holder 80 may be fitted into the groove 3A in the lower terminal 70 and may be coupled thereto. Accordingly, by virtue of the coupling between the protrusion and the groove, it is possible to increase the coupling force between the lower terminal 70 and the holder 80 and to suppress or inhibit rotation of the lower terminal 70.

The lower terminal 70 may include at least one protrusion 4a formed at the second portion 6a or 6c. The protrusion 4a may be formed on the outer surface of the lower terminal 70, and may project toward the outer surface of the lower terminal 70 from the inner surface of the lower terminal 70. For example, the protrusion 4a may include a plurality of (for example, two) protrusions, which are formed at two opposite portions of the lower terminal 70.

The liquid lens unit 130, which is shown in FIGS. 4A, 4B, and 6, may be assembled in the following sequence.

First, the upper terminal 60 may be coupled to the holder 80.

Subsequently, the holder 80, to which the upper terminal 60 is coupled, may be turned over so as to take the state of the bottom view shown in FIG. 6, and a conductive adhesive may be applied to the lower surfaces of the first portions 53a (or the first couplers) of the first to fourth upper terminals 61-1 to 61-4 of the upper terminal 60. Here, the bottom surfaces of the first portions 53a may be the lower surfaces of the first portions 53a of the first to fourth upper terminals 61-1 to 61-4 when viewed in the top view of FIG. 4A.

Subsequently, the liquid lens 50, which has been turned over, may be fitted into the bore 81 in the holder 80 such that the lower surfaces of the first portions 53a of the first to fourth upper terminals 61-1 to 61-4 are coupled to the upper electrodes 51 to 54 of the liquid lens 50.

Subsequently, a conductive adhesive may be applied to the lower electrodes 50a to 50d of the liquid lens 50 and the terminal 62 of the upper terminal 60, and an adhesive may be applied to the lower surface of the holder 80.

Subsequently, the first portions 5a to 5d of the lower terminal 70 may be coupled to the lower electrode 50B of the liquid lens 50 using a conductive adhesive, the terminal 62 of the upper terminal 60 may be coupled to the second portion 6b (for example, the portion at which the uneven portion A1 is formed) of the lower terminal 70 using a conductive adhesive, and the second portions 6a to 6d of the lower terminal 70 may be coupled to the terminal 62 of the upper terminal 60 using an adhesive.

The first lens unit 111 may be disposed over the liquid lens unit 130, and may be a region into which light is introduced from outside the lens assembly 120. In other words, the first lens unit 111 may be disposed over the liquid lens unit 130 in the barrel unit 110.

The first lens unit 111 may be embodied as a single lens or two or more lenses. For example, the two or more lenses of the first lens unit 111 may be aligned with each other along the central axis so as to form an optical system.

Here, the central axis may mean the optical axis OA of the optical system, which is constituted by at least one of the first lens unit 111, the liquid lens unit 130 and the second lens unit 112 of the camera module 100, or may mean an axis parallel to the optical axis OA.

The optical axis OA may correspond to the central axis of the effective image area (or the active area) of the image sensor 160. In other words, the first lens unit 111, the liquid lens unit 130, the second lens unit 112, and the image sensor 160 may be aligned along the optical axis OA through active alignment (AA) so as to overlap one another.

Here, the active alignment may be an operation of aligning the optical axes of the first lens unit 111, the liquid lens unit 130, and the second lens unit 112 and controlling the axial relationship or distance between the image sensor 160 and the lens units 111, 130 and 112 in order to obtain a better image.

Although the outside diameters of the lenses included in the first lens unit 111 may sequentially increase downwards (for example, in the −z-axis direction), the disclosure is not limited thereto.

An exposed lens (not shown) may be provided in front of or on the front surface of the first lens unit 111. Here, the exposed lens may project outwards from the barrel unit 110 so as to be exposed. In order to protect the surface of the exposed lens, a cover glass or a coating layer may be provided in front of the exposed lens.

The second lens unit 112 may be disposed under the liquid lens unit 130 in the barrel unit 110. The second lens unit 112 may be spaced apart from the first lens unit 111 in the optical-axis direction (for example, in the z-axis direction).

Light introduced into the first lens unit 111 from outside the camera module 100 may be introduced into the second lens unit 112 through the liquid lens unit 130. The second lens unit 112 may be embodied as a single lens or as two or more lenses aligned with each other along the central axis so as to form an optical system.

Unlike the liquid lens unit 130, each of the first lens unit 111 and the second lens unit 112 may be embodied as a solid lens made of glass or plastic. However, the disclosure is not limited with regard to the specific material of the first lens unit 111 or the second lens unit 112.

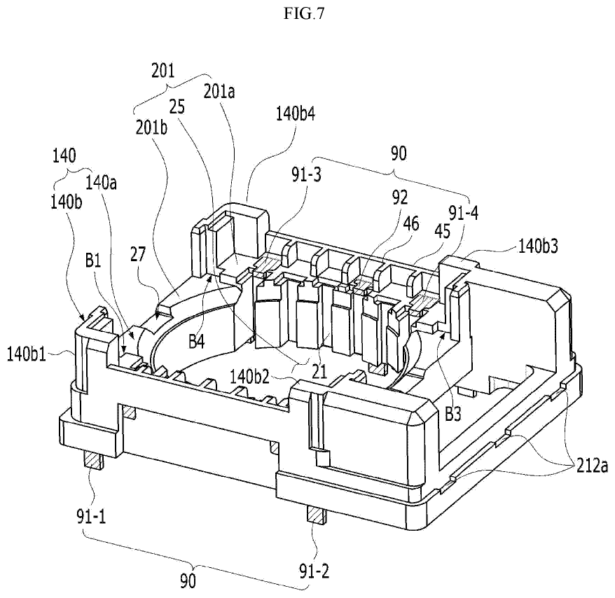

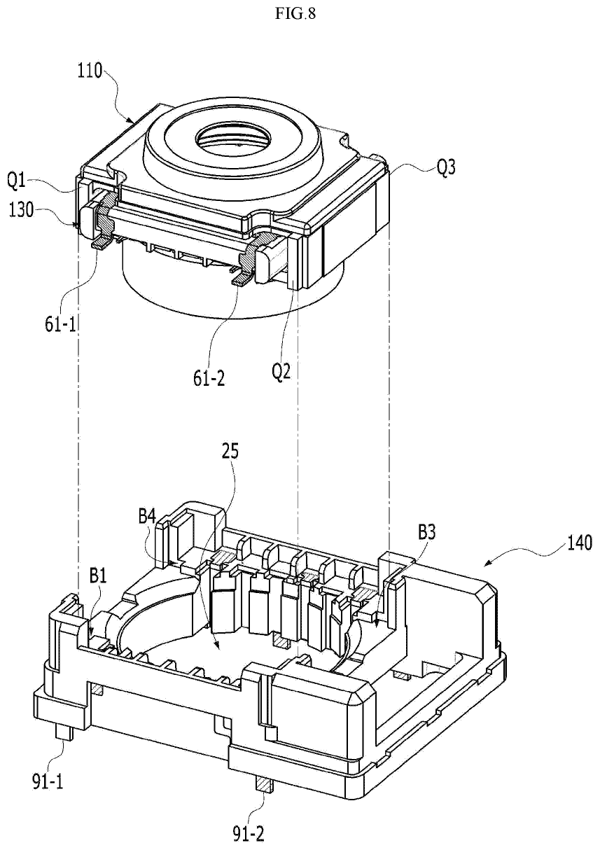

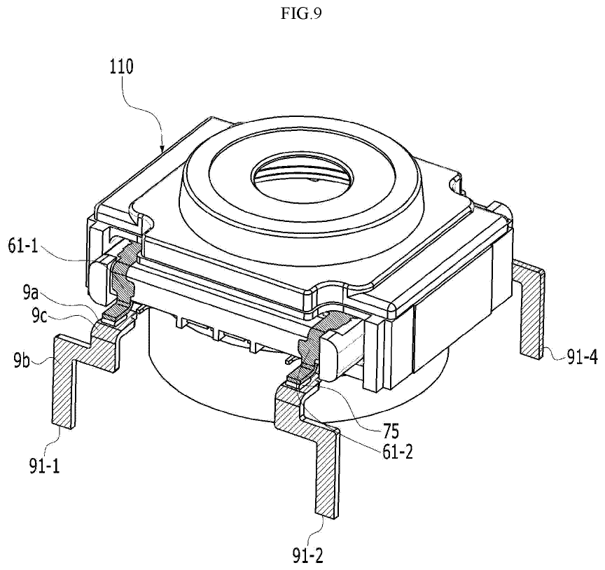

FIG. 7 illustrates the lens holder 140 and the electric connection member 90. FIG. 8 is a perspective view of the liquid lens unit 130, the electric connection member 90, and the lens holder 140, which are received in the barrel unit 110. FIG. 9 is a perspective view of the liquid lens unit 130 and the electric connection member 90, which are received in the barrel unit 110.

Referring to FIGS. 7 to 9, the lens holder 140 may be disposed under the holder 80, and may receive or support the barrel unit 110. For example, the lower surface of the holder 80, which is disposed or seated on the barrel unit 110, may be disposed higher than the upper surface of the lens holder 140.

The lens holder 140 may include a body 140a, and one or more columns 140b1 to 140b4, which project from the upper surface 201 of the body 140a in the optical-axis direction.

The body 140a may have therein a cavity or bore 25, in which at least a portion of the holder 80 is disposed or received.

The cavity 25 may have a shape that is identical to or coincides with the shape of at least a portion of the barrel unit 110. For example, although the cavity 25 may have a circular shape, an elliptical shape or a polygonal shape, the disclosure is not limited thereto. For example, the cavity 25 may be a hole formed through the lens holder 140 in the optical-axis direction.

The columns 140b1 to 140b4 may be formed at the corners of the lens holder 140, and may include a plurality of columns 140b1 to 140b4.

For example, the lens holder 140 may include the columns 140b1 to 140b4, which are formed at the four corners of the upper surface of the body 140a.

The inner circumferential surface of the lens holder 140 (for example, the side surface of the cavity 25) may have formed therein a groove 21. The groove 21 may be formed in the inner circumferential surface of the lens holder 140. The groove 21 may be disposed between the sensor base 180 and the liquid lens unit 130.

The groove 21 may be formed from the lower region of the lens holder 140 to a region of the lens holder 140 adjacent to the liquid lens unit 130. Here, the lower region of the lens holder 140 may be a region adjacent to the upper region of the sensor base 180.

The groove 21 may extend in the optical-axis direction. The upper end of the groove 21 may communicate with an opening in the upper surface of the lens holder 140, and the lower end of the groove 21 may communicate with an opening in the lower surface of the lens holder 140.

The groove 21 may include a plurality of grooves. For example, the inner circumferential surface of the lens holder 140 may be provided with the grooves 21 corresponding to the electric connection portions 91-1 to 91-4 of the electric connection member 90.

The grooves 21 may be spaces, in which supports configured to support or fix the electric connection portions 91-1 to 91-4 are positioned during insert injection molding for formation of the electric connection portions 91-1 to 91-4 and the lens holder 140. Here, the supports may be removed after the insert injection molding.

In the embodiment, the lens holder 140 may include a lower surface that faces the upper surface of the sensor base 180. The first adhesive 40 may be applied to the upper surface of the sensor base 180 and the lower surface of the lens holder 140.

The groove 21 in the lens holder 140 may be formed in the inner surface or the lower end of the lens holder 140 so as to serve as a path through which gas generated during hardening of the first adhesive 40 is discharged toward the liquid lens unit 130. Here, the groove formed in the inner surface or the lower end of the lens holder 140 may extend to the upper surface of the lens holder 140 from the lower surface of the lens holder 140 so as to define a thorough hole in a vertical direction (in the optical-axis direction) between the lens holder 140 and the barrel unit 110.

The lens holder 140 may include a side wall 45 disposed on the body 140a.

The side wall 45 may be formed on the upper surface 201 of the body 140a, and may project from the upper surface 201 of the body 140a in the optical-axis direction (for example, in an upward direction).

For example, the side wall 45 may be disposed between the first column 140b1 and the second column 140b2 and between the third column 140b3 and the fourth column 140b4.

For example, the side wall 45 may connect the first column 140b1 to the second column 140b2, and may connect the third column 140b3 to the fourth column 140b4.

For example, although the height of the upper surface of the side wall 45 may be lower than the height of the upper surfaces of the columns 140b1 to 140b4, the disclosure is not limited thereto. In another embodiment, the height of the upper surfaces of the columns 140b1 to 140b4 may be the same as or lower than the height of the upper surface of the side wall 45.

The lens holder 140 may include a partition wall 46 disposed on the body 140a.

The partition wall 46 may connect the upper surface of the body 140a to the inner surface of the side wall 45.

The partition wall 46 may be disposed in regions of the body 140a between the electric connection portions 91-1 to 91-4 and 92.

For example, the partition wall 46 may include a plurality of partition walls, and each of the plurality of partition walls 46 may be disposed in a corresponding one of the regions of the body 140a between the electric connection portions 91-1 to 91-4 and 92.

The plurality of partition walls 46 may partition the space between the lens holder 140 and the liquid lens unit 130 into a plurality of spaces, in respective ones of which the terminals 61-1 to 61-4 and 62 of the upper terminal 60 of the liquid lens unit 130 are respectively coupled to the electric connection portions 91-1 to 91-4 and 92 corresponding to the terminals 61-1 to 61-4 and 62 via a conductive adhesive.

The upper surface 201 of the lens holder 140 may include a first surface 201a.

A first coupler 9a of the electric connection member 700 may be disposed on the first surface 201a of the lens holder 140. The upper surface of the lens holder 140 may include a second surface 201b, which has a height difference in the optical-axis direction with respect to the first surface 201a. For example, the height of the second surface 201b may be lower than the height of the first surface 201a. For example, the distance between the lower surface of the lens holder 140 and the second surface 201b may be less than the distance between the lower surface of the lens holder 140 and the first surface 201a.

For example, the first surface 201a may be disposed or positioned at the first to fourth corners of the upper surface of the body 140a, a first area between the first corner and the second corner of the upper surface of the body 140a, and a second area between the third corner and the fourth corner of the upper surface of the body 140a.

For example, the second surface 201b may be disposed or positioned in a third area between the first corner and fourth corner of the upper surface of the body 140a and the fourth area between the second corner and the third corner of the upper surface of the body 140a.

The lens holder 140 may have therein a groove 27 formed in the second surface 201b. The groove 27 may be depressed from the second surface 201b. In an example, the groove 27 may include two grooves, which are respectively formed in the third area and the fourth area of the second surface 201b of the body 140a.

The barrel unit 110 may be bonded or fixed to the lens holder 140 using an adhesive (for example, epoxy). At this point, the groove 27 in the lens holder 140 may serve as a path through which gas generated during hardening of the adhesive is discharged to the outside of the lens holder 140. The groove 27 may serve as a vent hole for discharge of gas.

The lens holder 140 may have therein grooves B1 to B4 in which projections (or coupling protrusions) Q1 to Q4 of the barrel unit 110 are disposed.

The projections (or coupling protrusions) Q1 to Q4 of the barrel unit 110 may be fitted or coupled into the grooves B1 to B4 in the lens holder 140. For example, although the projections Q1 to Q4 may be disposed in the grooves B1 to B4 and may be spaced apart from the inner walls or the inner surfaces of the grooves B1 to B4, the disclosure is not limited thereto. In another embodiment, at least a portion of the projections Q1 to Q4 may be in contact with the inner wall or the inner surface of the grooves B1 to B4.

For example, the projections Q1 to Q4 may project in a direction perpendicular both to the optical axis and to the outer surface of the barrel unit 110.

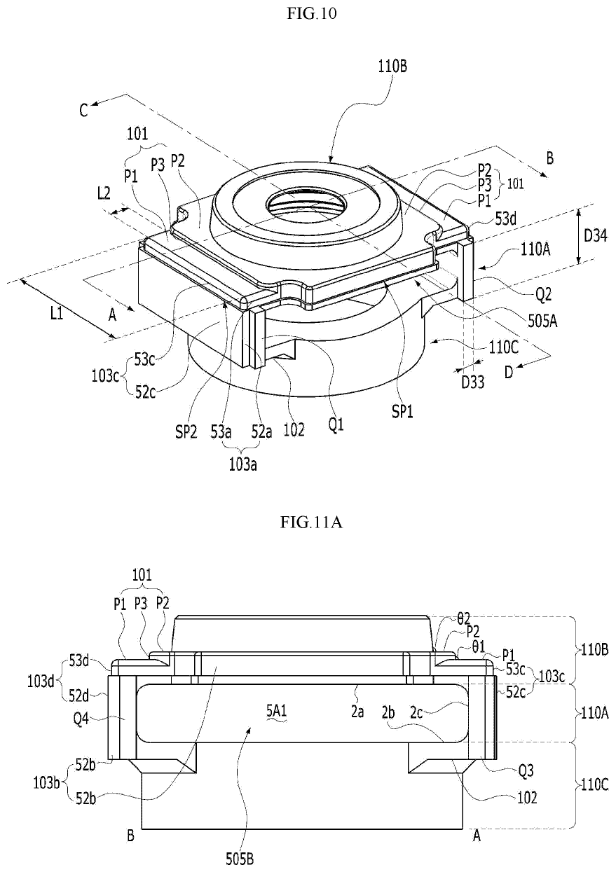

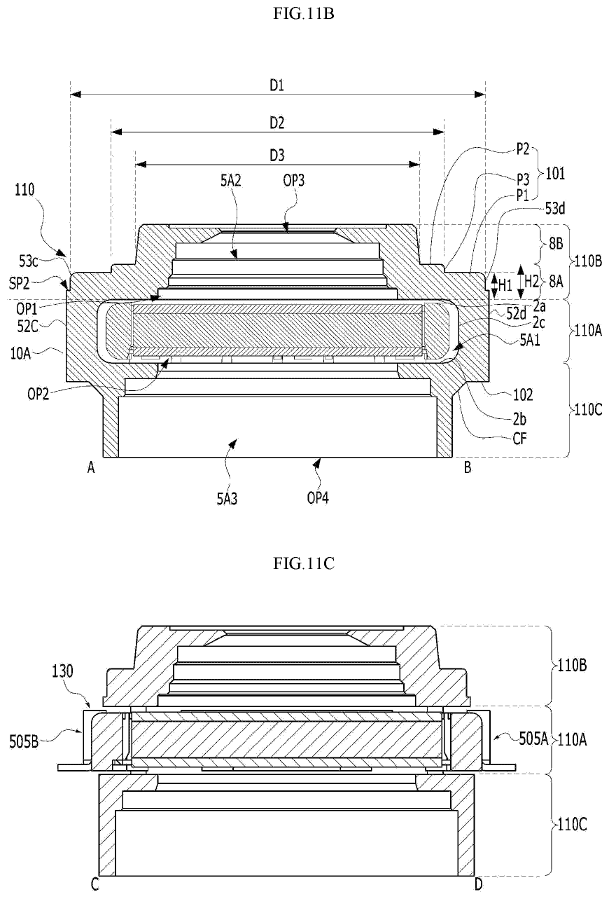

For example, the length D34 of the projections Q1 to Q4 in the optical-axis direction may be greater than the length D33 of the projections Q1 to Q4 in a crosswise direction (D34>D33, see FIG. 10).

For example, although the length D34 of the projections Q1 to Q4 in the optical-axis direction may be greater than the length of openings 505A and 505B in the barrel unit 110 in the optical-axis direction, the disclosure is not limited thereto. In another embodiment, the length of the projections in the optical-axis direction may be less than or equal to the length of the openings 505A and 505B in the barrel unit 110 in the optical-axis direction.

For example, the upper ends or the upper surfaces of the projections Q1 to Q4 may be positioned higher than the openings 505A and 505B in the barrel unit 110, and the lower ends or the lower surfaces of the projections Q1 to Q4 may be positioned lower than the openings 505A and 505B in the barrel unit 110.

For example, the grooves B1 to B4 in the lens holder 140 may be depressed from the first surface 201a of the lens holder 140. For example, the grooves B1 to B4 may be configured so as to be depressed from the first surface 201a to the second surface 201b of the lens holder 140.

The grooves B1 to B4 in the lens holder 140 may have openings that face the projections Q1 to Q4. For example, the barrel unit 110 may include four projections Q1 to Q4, and the lens holder 140 may have four grooves B1 to B4, which correspond to or face the four projections Q1 to Q4. However, the number of projections and the number of grooves are not limited thereto, and may be respectively one or more.

The lens holder 140 may include a step 212 or a shoulder 212.

The step 212 may be formed on the outer surface of the lens holder 140.

The step 212 may be formed at the lower end of the outer surface of the lens holder 140.

The side plate 302 of the cover 300 may be disposed on the step 212.

A groove 212a may be formed in the step 212 of the lens holder 140. For example, the groove 212a may be formed in the upper portion or the upper surface of the step 212. For example, although the step 212 and the side plate 302 of the cover 300 may be coupled to each other, the disclosure is not limited thereto. In another embodiment, the step and the side plate may be spaced apart from each other.

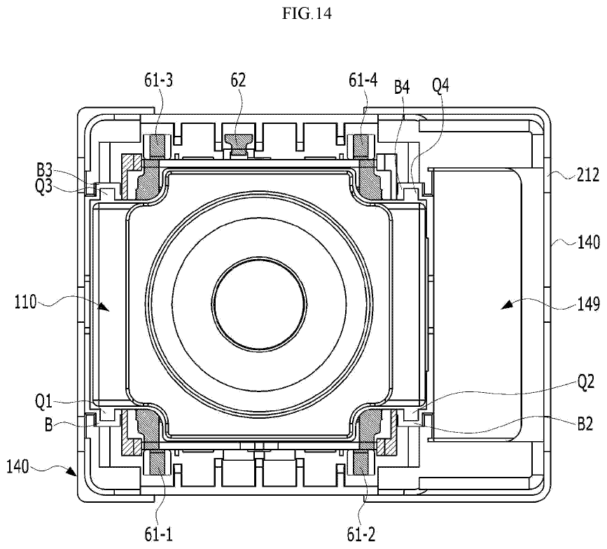

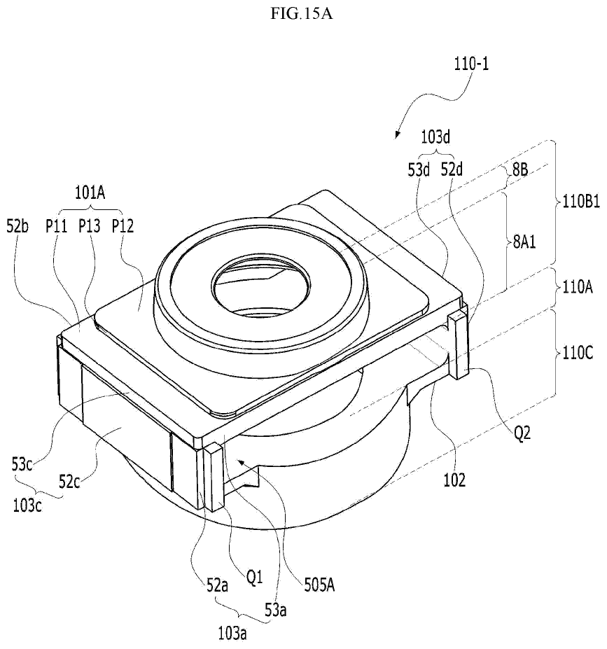

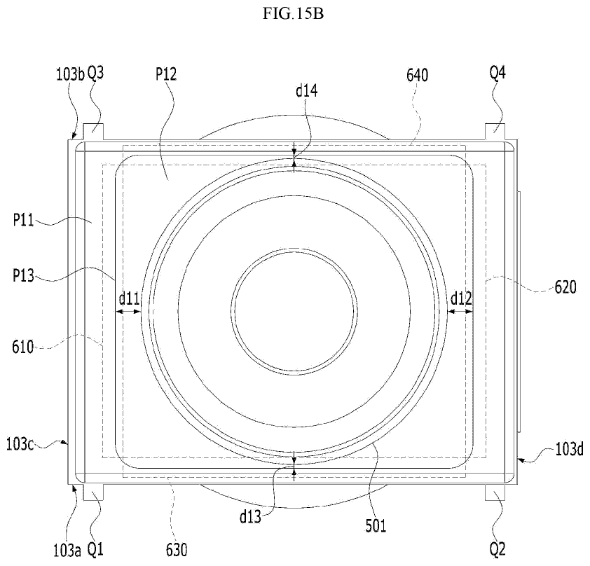

The lens holder 140 may have a hole 149 (see FIG. 14), which is spaced apart from the cavity 25 and through which the circuit element 170 is exposed.

The electric connection member 90 may be disposed at the lens holder 140, and may be conductively connected to the upper terminal 60 of the liquid lens unit 130. Furthermore, the electric connection member 90 may be conductively connected to the terminals 195 of the circuit board 190.

The electric connection member 90 may be spaced apart from the cover 300. The electric connection member 90 may be formed as a single integral unit.

The electric connection member 90 may include the plurality of electric connection portions 91-1 to 91-4 and 92. Although twelve electric connection portions are illustrated in FIG. 7, the number of electric connection portions is not limited thereto. The electric connection member 90 may include one or more electric connection portions. The electric connection portion may alternatively be referred to as a “terminal”, an “electrode”, a “bonding portion”, or a “lead frame”.

Each of the terminals 61-1 to 61-4 and 62 of the upper terminal 60 may be conductively connected or coupled to a corresponding one of the electric connection portions 91-1 to 91-4 and 92 via a conductive adhesive 75.

Referring to FIG. 9, each of the electric connection portions 91-1 to 91-4 and 92 may include the first coupler 9a, which is coupled to the upper electrode 60 via the conductive adhesive 75. The first coupler 9a may be in contact with the conductive adhesive 75.

The conductive adhesive 75 may include at least one of solder and a conductive adhesive. For example, the conductive adhesive 75 may include Ag epoxy. The conductive adhesive 75 may be disposed between the plurality of partition walls 46 of the lens holder 140.

The first coupler 9a may be disposed on the first surface 201a of the upper surface of the lens holder 140. For example, although the upper surface of the first coupler 9a may be flush with the first surface 201a of the upper surface of the lens holder 140, the disclosure is not limited thereto.

At least a portion of the upper surface of the first coupler 9a may be exposed from the upper surface (for example, the first surface 201a) of the lens holder 140.

The first coupler 9a of each of the electric connection portions may overlap a corresponding second coupler 53b or 54b of the upper terminal 60 of the liquid lens unit 130 in a vertical direction.

Each of the electric connection portions 91-1 to 91-4 and 92 may further include a second coupler 9b, which is connected to a corresponding one of the terminals of the circuit board 190.

For example, a portion of the second coupler 9b may be exposed from the outer surface of the lens holder 140. For example, although the second coupler 9b may project downwards from the lower surface of the lens holder 140, the disclosure is not limited thereto. In another embodiment, the second coupler 9b may not project downwards from the lower surface of the lens holder 140.

Although, in an example, the second coupler 9b may include a linear portion and a bent portion, the disclosure is not limited thereto. In another embodiment, the second coupler 9b may include at least one of the linear portion and the bent portion.

Each of the electric connection portions 91-1 to 91-4 and 92 may further include a connector connecting the first coupler 9a to the second coupler 9b.

For example, although the connector 9c may have a bent shape and may be positioned in the lens holder 140, the disclosure is not limited thereto. In another embodiment, the connector 9c may be exposed to the outside of the lens holder 140.

Although the conductive adhesive 75 is explained as a separate component independent of the electric connection member 90, the conductive adhesive 75 may be a single component integrally formed with the conductive member 90.

In the embodiment, the lower surface of the liquid lens unit 130 may be disposed on the upper surface 201 of the lens holder 140. Here, the conductive adhesive 75, which connects the upper terminal 60 of the liquid lens unit 130 to the electric connection member 90, may be disposed on the upper surface 201 of the lens holder 140.

In the embodiment, a portion (for example, 53b or 54b) of the upper terminal 60 of the liquid lens unit 130 may be embedded in the conductive adhesive 75. As a result, the upper terminal 60 of the liquid lens unit 130 may be conductively connected even without applying external pressure to the upper terminal 60.

According to the embodiment, it is possible to ensure a stable resistance by increasing the contact area of the conductive adhesive 75 between the upper terminal 60 of the liquid lens unit 130 and the electric connection member 90.

Each of the electric connection portions 91-1 to 91-4 and 92 of the electric connection member 90 may include a conductive layer formed on the surface of the lens holder 140. Here, the conductive layer may be formed on the surface of the lens holder 140 using a molded interconnection device (MID) technology.

The conductive layer may extend along the upper surface 201 and the outer surface of the lens holder 140, and may be connected at one end thereof to the terminal 195 of the circuit board 190 and at the other end thereof to the upper terminal 60 of the liquid lens unit 130.

In a modification, the conductive layer of each of the electric connection portions 91-1 to 91-4 and 92 of the electric connection member 90 may be formed at the lens holder 140 through insert injection molding.

For example, at least a portion of each of the electric connection portions 90-1 to 91-4 and 92 may have a width different from the width of another portion.

The cover 300 may cover the lens holder 140, and may receive therein the lens holder 140.

The cover 300 may define the appearance of the camera module 100. The cover 300 may be configured to have the form of a polyhedron, for example, a hexahedron, which is open at the lower surface thereof.

The cover 300 may be a nonmagnetic body. The cover 300 may be made of metal.

For example, the cover 300 may be made of a metal plate.

The cover 300 may be connected to the ground of the circuit board 190. Accordingly, the cover 300 may be grounded. The cover 300 may block electromagnetic interference (EMI). In this case, the cover 300 may be referred to as an “EMI shield can”.

The cover 300 may include an upper plate and a side plate 302 extending from the upper plate 301. The upper plate 301 of the cover 300 may have therein a bore (or hole) 303, through which at least a portion of the barrel unit 110 is exposed.

The side plate 302 of the cover 300 may have therein an opening or groove 311, through which at least a portion of the electric connection member 90 is exposed.

For example, the side plate 302 of the cover 300 may include first and second side plates, which face each other, and third and fourth side plates, which connect the first and second side plates to each other.

For example, the opening 311 may be formed in the lower portion or the lower end of at least one of the first and second side plates of the side plate 302 of the cover 300 so as to expose the second coupler 9b of at least one of the electric connection portions 91-1 to 91-4 and 92.

The side plate 302 of the cover 300 may have formed therein a groove 312, which corresponds to the groove 212a in the lens holder 140. For example, the groove 312 may be formed in the lower portion or the lower end of at least one of the third and fourth side plates of the side plate 302 of the cover 300.

An adhesive may be injected into the space between the groove 312 in the side plate 302 of the cover 300 and the groove 212a in the lens holder 140 such that the cover 300 is coupled to the lens holder 140 by means of the injected adhesive.

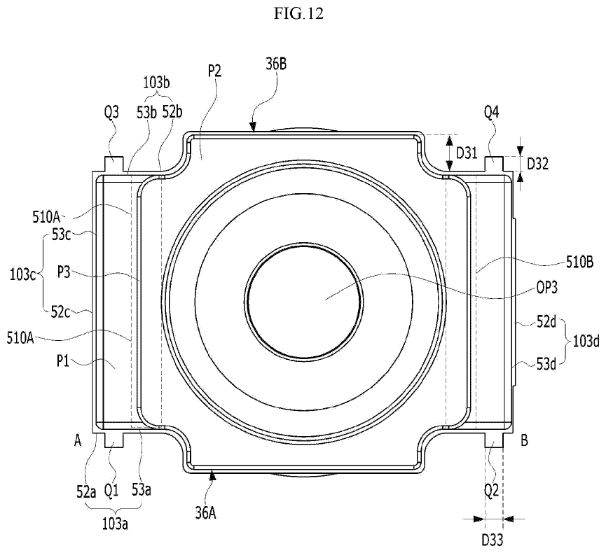

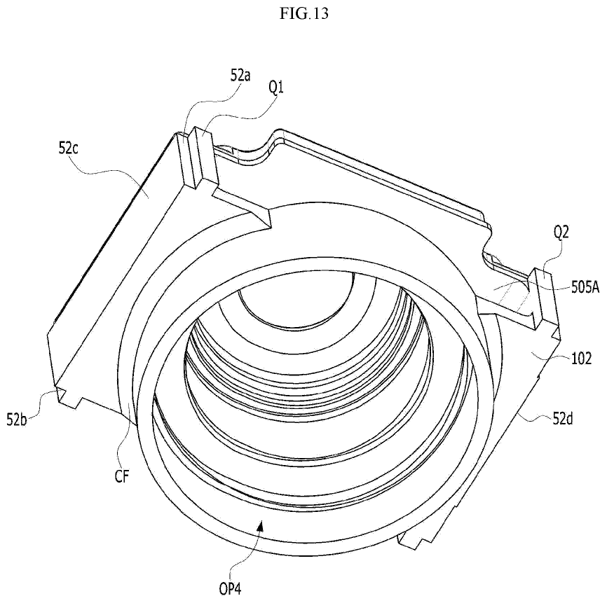

FIG. 10 is a perspective view of the barrel unit 110 according to the embodiment. FIG. 11A is side view of the barrel unit 110 shown in FIG. 10. FIG. 11B is a cross-sectional view of the liquid lens unit 130 and the barrel unit 110 taken along line A-B in FIG. 10. FIG. 11C is a cross-sectional view of the first lens unit and the barrel unit 110 taken along line C-D in FIG. 10. FIG. 12 is a plan view of the barrel unit 110. FIG. 13 is a bottom view of the barrel unit 110. FIG. 14 is a plan view of the barrel unit 110, the liquid lens unit 130, the electric connection member, and the lens holder shown in FIG. 8. FIG. 11A is a side view of the barrel unit 110 shown in FIG. 10 when viewed from the rear side or behind of the barrel unit 110.

The barrel unit 110 may include side surfaces 103a to 103d, which have therein openings 505A and 505B, in which at least a portion of the liquid lens unit 130 is disposed, and the projections Q1 to Q4, which are formed adjacent to the openings 505A and 505B.

The barrel unit 110 may include an upper surface 101, which is connected to the side surface 103 and has a step. The upper surface 101 of the barrel unit 110 may include a first region P1 and a second region P2, which has a height difference in the optical-axis direction with the first region P1.

The barrel unit 110 may include the first surface 101, a second surface 102, which is disposed opposite the first surface 101, the side surfaces 103a to 103d connecting to the first surface 101 to the second surface 102, and the openings 505A and 505B, which are formed in the side surfaces 103a to 103d and in which at least a portion of the liquid lens unit 130 is disposed.

For example, the first surface 101 of the barrel unit 110 may be the upper surface of the barrel unit 110, and the second surface 102 of the barrel unit 110 may be the lower surface of the barrel unit 110.

For example, the barrel unit 110 may include chamfers, which are formed at the portions between the first surface 101 and the side surfaces 103a to 103d. The portions between the first surface 101 and the side surfaces 103a to 103d may be rounded or may be curved surfaces each having a predetermined curvature.

The side surfaces 103a to 103d of the barrel unit 110 may be provided with one or more steps SP1 and SP2. For example, the side surfaces 53a to 53d of a first body 8A of a second barrel portion 110B, which will be described later, may be provided with one or more steps SP1 and SP2.

The first lens unit 111 may be disposed at the barrel unit 110 and at one side of the liquid lens unit 130, and the second lens unit 112 may be disposed at the barrel unit 110 and at the other side of the liquid lens unit 130. For example, the liquid lens unit 130 may be disposed between the first lens unit 111 and the second lens unit 112 in the barrel unit 110.

The first surface 101 of the barrel unit 110 may include a stepped portion, which includes the first region P1 and the second region P2, having a height difference with respect to the first region P1.

The first region P1 of the first surface 101 of the barrel unit 110 may be connected to the side surface 103 of the barrel unit 110, and the second region P2 of the first surface 101 may be disposed higher than the first region P1.

The barrel unit 110 may include a first portion at which the first lens unit 111 is disposed, and the first portion may project from the second region P2 of the barrel unit 110.

The first portion of the barrel unit 110 may correspond to a second body 8B of the second barrel portion 110B, which will be described later, and may alternatively be referred to as a projection or an upper projection.

For example, the first portion of the barrel unit 110 may project upwards from the second region P2 of the barrel unit 110 or toward the first surface 101 from the second surface 102.

The barrel unit 110 may include a second portion, at which the second lens unit 112 is disposed, and the second portion may project from the second surface 102. For example, the second portion of the barrel unit 110 may project downwards from the second surface 102 of the barrel unit 110 or toward the second surface 102 from the first surface 101. The second portion of the barrel unit 110 may correspond to a portion of a third barrel portion 110C, which will be described later, and may alternatively be referred to as a projection or a lower projection.

The crosswise length of the first portion of the barrel unit 110, which projects from the second region P2 of the barrel unit 110, may be less than the crosswise length of the body 10A of the barrel unit 110, at which the liquid lens unit is disposed. For example, the crosswise length of the second portion of the barrel unit 110, which projects from the second surface 102 of the barrel unit 110, may be less than the crosswise length of the body 10A of the barrel unit 110. For example, the crosswise length of the first portion of the barrel unit 110, which projects from the second region P2 of the barrel unit 110, may be less than or equal to the crosswise length of the second portion of the barrel unit 110, which projects from the second surface 102 of the barrel unit 110.

For example, the barrel unit 110 may include a chamfer CF, which is formed at the portion between the second portion of the barrel unit 110 and the second surface of the barrel unit 110.

The side surface 103 of the barrel unit 110 may include a first side surface 103a and a second side surface 103b, which face each other. A first opening 505A may be formed in the first side surface 103a of the barrel unit 110, and a second opening 505B may be formed in the second side surface 103b of the barrel unit 110.

Furthermore, the side surface 103 of the barrel unit 110 may include a third side surface 103c and a fourth side surface 103d, which connect the first side surface 103a to the second side surface 103b and face each other.

The width or length L2 of the first region P1 in a direction perpendicular to the third side surface 103c of the barrel unit 110 may be less than the width or length L1 of the first region P1 in a direction perpendicular to the first side surface 103a of the barrel unit 110 (L2<L1).

The first region P1 of the barrel unit 110 may be connected to the third side surface 103c and the fourth side surface 103d of the barrel unit 110.

Referring to FIG. 12, the stepped portion may include a first stepped portion 510A and a second stepped portion 510B, which are formed between the third side surface 103c and the fourth side surface 103d of the barrel unit 110.

For example, the first stepped portion 505A may be disposed parallel to the third side surface 103c of the barrel unit 110, and the second stepped portion 505B may be disposed parallel to the fourth side surface 103d of the barrel unit 110.

Although each of the first and second stepped portions may have a linear or straight-line shape, the disclosure is not limited thereto. In another embodiment, the stepped portion may have a curved or rounded shape.

The barrel unit 110 may include the projections Q1 to Q4, which project from at least one of the first side surface 103a and the second side surface 103b of the barrel unit 110.

For example, the projections Q1 to Q4 may include first projections Q1 and Q2, which are formed at one or more of the two sides of the first opening 505A in the barrel unit 110, and second projections Q3 and Q4, which are formed at one or more of the two sides of the second opening 505B in the barrel unit 110.

The barrel unit 110 may include the first barrel portion 110A, in which the liquid lens unit 130 is disposed or received, the second barrel portion 110B, in which the first lens unit 111 is disposed or received, and the third barrel portion 110C, in which the second lens unit 112 is disposed or received.

The second barrel portion 110B may extend from the first barrel portion 110A, and may be disposed on the first barrel portion 110A.

The third barrel portion 110C may extend from the first barrel portion 110A, and may be disposed beneath the first barrel portion 110A.

The first barrel portion 110A may include the body 10A and a reception space 5A1 formed in the body 10A. The liquid lens unit 130 may be disposed in the reception space in the body 10A of the first barrel portion 110A. The reception space 5A1 may have a shape suitable for receiving the liquid lens unit 130. Here, the “reception space” may alternatively be referred to as a “space”.

For example, the body 10A of the first barrel portion 110A may include an internal upper surface 2a, an internal lower surface 2b, and an internal side surface 2c connecting the internal upper surface 2a to the internal lower surface 2b, in order to define the reception space 5A1.

The body 10A of the first barrel portion 110A may include a first side surface (or a first outer surface) 52a and a second side surface (or a second outer surface) 52b, which are positioned opposite each other, and a third side surface (or a third outer surface) 52c and a fourth side surface (or a fourth outer surface) 52d, which connect the first side surface 52a to the second side surface 52b and are positioned opposite each other. For example, the reception space 5A1 in the first barrel portion 110A may be formed inside the first to fourth side surfaces 52a to 52d of the body 10A of the first barrel portion 110A.

One or more of the first side surface 52a and the second side surface 52b of the first barrel portion 110A may be provided with one or more openings 505A and 505B, through which the liquid lens unit 130 is fitted or assembled.

For example, the first barrel portion 110A may have therein the first opening 505A, which is formed in the first side surface 52a of the body 10A, and the second opening 505B, which is formed in the second side surface 52b of the body 10A.

By virtue of the first and second openings 505A and 505B, the reception space 5A1 in the body 10A of the first barrel portion 110A may be open toward the outside of the body 10A.

Referring to FIG. 11C, one end of the first lens unit 111 may project outwards beyond the first opening 505A in the first barrel portion 110A, and the other end of the first lens unit 111 may project outwards beyond the second opening 505B in the first barrel portion 110A.

The second barrel portion 110B may include the first surface 101, and the side surfaces 53a to 53d, which connect the first surface 101 to the side surfaces 52a to 52d of the first barrel portion 110A.

The first surface 101 of the second barrel portion 110B may be the upper surface of the second barrel portion 110B.

The description of the first surface 101 of the barrel unit 110 may be applied to the first surface 101 of the second barrel portion 110B, with or without modification.

For example, the second barrel portion 110B may include the first body 8A, which is disposed on the barrel portion 110A, and the second body 8B, which is disposed on the first body 8A.

The upper surface of the first body 8A may include the stepped portion, which includes the first region P1 and the second region P2, which has a height difference in the optical-axis direction with respect to the first region P1.

For example, the upper surface of the first body 8A may further include a third region P3, connecting the first region Pb to the second region P2. Here, the stepped portion of the first body 8A may include the first region P1 and the second region P2. Furthermore, the stepped portion of the first body 8A may include the first to third regions P1 to P3. For example, although the third region P3 may have a flat surface, the disclosure is not limited thereto. The third region P3 may include a curved surface or at least one bent portion.

The second region P2 of the upper surface of the first body 8A may abut on the lower portion or the lower end of the second body 8B, and the first region P1 of the upper surface of the first body 8A may abut on the upper portion or the upper end of the side surface of the first body 8A.

The second body 8B may project upwards from the upper portion of the first body 8A.

For example, the second body 8B may project from the second region P2 of the first body 8A in the optical-axis direction or in the upward direction.

The second region P2 of the upper surface of the first body 8A may be formed around the lower portion or the lower end of the second body 8B so as to surround the lower portion or the lower end of the second body 8B.

For example, the periphery of the second region P2 of the upper surface of the first body 8A may be spaced apart from the boundary between the lower portion or the lower end of the second body 8B and the second region P2.

For example, although the third region P3 of the first body 8A may be parallel to the third side surface 52c (or the fourth side surface 52d) of the first barrel portion 110A, the disclosure is not limited thereto.

The first body 8A may include a first side surface (or a first outer surface) 53a corresponding to the first side surface 52a of the first barrel portion 110A, a second side surface (or a second outer surface) 53b corresponding to the second side surface 52b of the first barrel portion 110A, a third side surface (or a third outer surface) 53c corresponding to the third side surface 52c of the first barrel portion 110A, and a fourth side surface (or a fourth outer surface) 53d corresponding to the fourth side surface 52d of the first barrel portion 110A.

Referring to FIG. 12, the stepped portions 510A and 510B of the second barrel portion 110B may extend to the second side surface 53b from the first side surface 53a of the first body 8A. For example, one end of each of the stepped portion 510A and 510B of the first body 8A of the second barrel portion 110B may abut on the first side surface 53a of the first body 8A, and the other end of each of the stepped portion 510A and 510B of the first body 8A of the second barrel portion 110B may abut on the second side surface 53b of the first body 8A.

For example, each of the stepped portions 510A and 510B may include a first curved portion or a first round portion connecting one end of each of the stepped portions 510A and 510B to the first side surface 53a of the first body 8A. Furthermore, each of the stepped portions 510A and 510B may include a second curved portion or a second round portion connecting the other end of each of the stepped portions 510A and 510B to the second side surface 53b of the first body 8A.

In another embodiment, each of the stepped portions of the first body 8A of the second barrel portion 110B may be spaced apart from at least one of the first side surface 53a and the second side surface 53b of the first body 8A.

For example, the stepped portions of the second barrel portion 110B may include a first stepped portion 510A, which is disposed at one side of the second body 8B of the second barrel portion 110B, and a second stepped portion 510B, which is disposed at the other side of the second body 8B of the second barrel portion 110B.

For example, although the third region P3 of the first stepped portion 510A may be parallel to the third side surface 53c of the first body 8A of the second barrel portion 110B or the third side surface 52c of the first barrel portion 110A and the third region P3 of the second stepped portion 510B may be parallel to the fourth side surface 53d of the first body 8A of the second barrel portion 110B or the fourth side surface 52d of the first barrel portion 110A, the disclosure is not limited thereto. In another embodiment, the third region P3 may not be parallel to the side surface.

For example, although the included angle (01, see FIG. 11A) between the third region P3 of the first body 8A and the first region P1 of the first body 8A may be a right angle, the disclosure is not limited thereto. In another embodiment, the included angle θ1 may be a obtuse angle or an acute angle.

For example, the second body 8B may project from the second region P2 of the first body 8A in the optical-axis direction or in the upward direction.

The distance D2 between the third region P3 of the first stepped portion 510A and the third region P3 of the second stepped portion 510B may be less than the distance D1 between the third side surface 53c and the fourth side surface 53d of the first body 8A (D2<D1).

Referring to FIG. 3A, at least a portion of the second barrel portion 110B may be exposed through the bore 303 in the cover 300. For example, the second body 8B of the second barrel portion 110B may be exposed through the bore 303 in the cover 300. For example, the second body 8B of the second barrel portion 110B may project outwards from the cover 300 through the bore 303 in the cover 300.

For example, the second region P2 of the first body 8A of the second barrel portion 110B may be exposed through the bore 303 in the cover 300. For example, a portion of the first region P1 adjacent to the third region P3 of the first body 8A of the second barrel portion 110B may be exposed through the bore 303 in the cover 300.

The second region P2 of the first body 8A of the second barrel portion 110B may be positioned in the cover 300. For example, the second region P2 of the first body 8A of the second barrel portion 110B may be positioned lower than the upper surface 301 of the cover 300.

The diameter D21 of the bore 303 in the cover 300 may be greater than the distance D2 between the third region P3 of the first stepped portion 510A and the third region P3 of the second stepped portion 510B (D21>D2).

For example, D21 may be the crosswise length of the bore 303 in the cover 300.

For example, D2 may be the distance between the two outer edges of the second region P2, which face each other in a crosswise direction. Alternatively, D2 may be the distance between the third region P3 of the first stepped portion 510A and the third region P3 of the second stepped portion 510B.

Here, the crosswise direction may be a direction that is perpendicular to the optical axis and is directed from one side plate of the cover 300, which faces the third side surface 52c of the barrel unit 110, toward the other side plate of the cover 300, which faces the fourth side surface 52d of the barrel unit 110.

The inner surface of at least a portion of the upper plate 301 of the cover 300 may face or overlap the first region P1 of the second barrel portion 110B of the barrel unit 110 in the optical-axis direction.

For example, the inner surface of a portion of the upper plate 301 of the cover 300 adjacent to the bore 303 may face or overlap the first region P1 of the second barrel portion 110B in the optical-axis direction.

The upper plate 301 of the cover 300 may not face or overlap the second region P2 of the second barrel portion 110B in the optical-axis direction.

For example, the inner surface of the upper plate 301 of the cover 300 may be positioned higher than the first region P1 of the second barrel portion 110B. For example, the inner surface of the upper plate 301 of the cover 300 may be positioned lower than the second region P2 of the second barrel portion 110B. In another embodiment, the inner surface of the upper plate 301 of the cover 300 may be positioned at the same level as the second region P2 of the second barrel portion 110B. Accordingly, it is possible to avoid spatial interference between the upper plate 301 of the cover 300 and the second region P2 of the second barrel portion 110B, and it is possible to inhibit an increase in the length (or the height) of the camera module 100 in the optical-axis direction.

In other words, it is possible to avoid spatial interference between the stepped portion 510 and the cover 300 by virtue of the bore 303 in the cover 300.

Although the appearance of the second body 8B may have a cylindrical form, the disclosure is not limited thereto. The second body 8B may be embodied so as to have any of various forms, such as the form of a polygonal column.

The included angle θ2 between the outer surface of the second body 8B and the second region P2 of the first body 8A may be an obtuse angle. Because θ2 is an obtuse angle, the second body 8B may be configured to be inclined with respect to the second region P2, and thus it is possible to inhibit deformation of an injection-molded product when the injection-molded product is taken out of or separated from a mold in an injection molding operation for formation of the lens unit. In another embodiment, 02 may be a right angle.

The second barrel portion 110B may have therein a reception space 5A2 for receiving therein the first lens unit 111, and the third barrel portion 110C may have therein a reception space 5A3 for receiving therein the second lens unit 112.

The inside of the first barrel portion 110A, the inside of the second barrel portion 110B, and the inside of the third barrel portion 110C may communicate with one another.

For example, the first barrel portion 110A may have therein a third opening OP1, which connects the reception space 5A1 in the first barrel portion 110A with the reception space 5A2 in the second barrel portion 110B. For example, the third opening OP1 in the first barrel portion 110A may be defined in the internal upper surface 2a of the first barrel portion 110A.

Furthermore, the first barrel portion 110A may have therein a fourth opening OP2, which connects the reception space 5A1 in the first barrel portion 110A with the reception space 5A3 in the third barrel portion 110C. For example, the fourth opening OP2 in the first barrel portion 110A may be defined in the internal lower surface 2b of the first barrel portion 110A.

Referring to FIG. 11B, for example, the crosswise length of the reception space 5A1 in the first barrel portion 110A may be greater than the crosswise length of each of the reception space 5A2 in the second barrel portion 110B and the reception space 5A3 in the third barrel portion 110C.

Here, the crosswise direction may be a direction that is perpendicular to the optical axis and is directed toward the fourth side surface 103d from the third side surface 103c of the barrel unit 110. For example, although the reception space 5A2 in the second barrel portion 110B may be smaller than the reception space 5A3 in the third barrel portion 110C, the disclosure is not limited thereto. In another embodiment, the former may be equal to or larger than the latter.

For example, the crosswise length of the liquid lens unit 130 may be less than the crosswise length of the reception space 5A1 in the first barrel portion 110A.

Referring to FIG. 11B, the crosswise length of the liquid lens unit 130 may be greater than the diameter (or the crosswise length) of the lenses of the first lens unit 111.

For example, although the orthogonal length of the liquid lens unit 130 may be greater than the orthogonal length of the reception space 5A1 of the first barrel portion 110A, the disclosure is not limited thereto. In another embodiment, the former may be equal to the latter.

Here, the orthogonal direction may be a direction that is perpendicular both to the optical-axis direction and to the crosswise direction. In other words, the orthogonal direction may be a direction that is perpendicular to the optical-axis direction and is directed toward the second side surface 103b from the first side surface 103a of the barrel unit 110.

Referring to FIG. 11C, for example, the orthogonal length of the liquid lens unit 130 may be greater than the diameter (or the orthogonal length) of the lenses of the first lens unit 111.

For example, the crosswise length of the liquid lens unit 130 may be greater than the crosswise length of each of the lenses of the first lens unit 111.

For example, the second lens unit 112 may include at least one lens having a diameter that is less than the crosswise length (or the orthogonal length) of the liquid lens unit 130. For example, the second lens unit 112 may include at least one lens having a diameter that is greater than or equal to the crosswise length (or the orthogonal length) of the liquid lens unit 130.

For example, the crosswise length of each of the lenses of the second lens unit 112 may be greater than or equal to the crosswise length of the liquid lens unit 130.

The second barrel portion 110B may have therein an opening OP3, through which at least a portion of the first lens unit 111, for example, the uppermost lens, is exposed.

For example, the inner wall of the second barrel portion 110B, which defines the reception space 5A2, may have at least one stepped structure. Although the peripheral region of the lens of the first lens unit 111 may be in surface contact with the stepped structure, the disclosure is not limited thereto.

The third barrel portion 110C may have an opening OP3, through which at least a portion of the second lens unit 112, for example, the lowermost lens, is exposed. For example, the inner wall of the third barrel portion 110C, which defines the reception space 5A3, may include at least one stepped structure. Although the peripheral region of the lens of the second lens unit 112 may be in surface contact with the stepped structure, the disclosure is not limited thereto.

Referring to FIG. 11B, the third region P3 of the stepped portion 510 of the second barrel portion 110B may overlap the reception space 5A1 in the first barrel portion 110A in the optical-axis direction. Accordingly, it is possible to inihibit the strength of the second barrel portion 110B of the barrel unit 110 from being weakened due to the reception space 5A1 in the first barrel portion 110A and to reinforce the strength of the barrel unit 110.

For example, the second body 8B of the second barrel portion 110B and the second region P2 of the first body 8A may overlap the reception space 5A1 in the first barrel portion 110A. Accordingly, it is possible to inhibit the strength of the second barrel portion 110B of the barrel unit 110 from being weakened due to the reception space 5A1 in the first barrel portion 110A and to reinforce the strength of the barrel unit 110.

The height H2 to the second region P2 of the first body 8A of the second barrel portion 110B from the first barrel portion 110A may be greater than the height H1 to the first region P1 of the first body 8A of the second barrel portion 110B from the first barrel portion 110A (H2>H1).

For example, the height difference between the first region P1 and the second region P2 of each of the stepped portions 510A and 510B may be the difference between H1 and H2.

Because the second barrel portion 110B includes the stepped portions 510A and 510B, the height H2 may be greater than the height H1 (H2>H1). Due to the stepped portions 510A and 510B, the area of the outer circumferential surface of the second barrel portion 110B or the cross-sectional area of the second barrel portion 110B in the crosswise direction may be increased.

Because the area of the outer circumferential surface of the second barrel portion 110B or the cross-sectional area of the second barrel portion 110B in the A-B direction is increased, the load that would otherwise be concentrated on the second barrel portion 110B due to the application of external force during an assembly operation is dispersed. Consequently, the embodiment is capable of suppressing deformation of the barrel unit 110 caused by external force during an assembly process. Here, the assembly process may include at least one of assembly of the barrel unit 110 with the lens assembly 120 and assembly of the barrel unit 110 with the lens holder 140.

Because the first body 8A, which is located between the first barrel portion 110A and the second body 8B of the second barrel portion 110B, has the thickness H2 (>H1) due to the stepped portions 510A and 510B, it is possible to increase the strength of the barrel unit 110 and thus to improve the structural reliability of the barrel unit 110.

The barrel unit 110 may include one or more projections Q1 to Q4, which project from at least one of the first side surface 52a and the second side surface 52b of the first barrel portion 110A.

The one or more projections Q1 to Q4 may project in a direction perpendicular to the optical axis.

For example, the barrel unit 110 may include the first projection Q1, which projects from one end of the first side surface 52a of the first barrel portion 110A, the second projection Q2, which projects from the other end of the first side surface 52a of the first barrel portion 110A, the third projection Q3, which projects from one end of the second side surface 52b of the first barrel portion 110A, and the fourth projection Q4, which projects from the other end of the second side surface 52b of the first barrel portion 110A.

Referring to FIGS. 11A and 13, the first projection Q1 may be positioned at one side of the first opening 505A in the first barrel portion 110A, and the second projection Q2 may be positioned at the other side of the first opening 505A in the first barrel portion 110A. For example, the first opening 505A in the first barrel portion 110A may be positioned between the first projection Q1 and the second projection Q2.

The third projection Q3 may be positioned at one side of the second opening 505B in the first barrel portion 110A, and the fourth projection Q4 may be positioned at the other side of the second opening 505B in the first barrel portion 110A. For example, the second opening 505B in the first barrel portion 110A may be positioned between the third projection Q3 and the fourth projection Q4.

Referring to FIGS. 10 to 12, the first body 8A of the second barrel portion 110B of the barrel unit 110 may include a first portion 36A, which projects from the first side surface 53a of the second barrel portion 110B in a direction toward the first side surface 53a from the second side surface 53b.

Furthermore, the first body 8A of the second barrel portion 110B of the barrel unit 110 may include a second portion 36B, which projects from the second side surface 53b of the second barrel portion 110B in a direction toward the second side surface 53b from the first side surface 53a.

For example, although the length D31 of each of the first portion 36A and the second portion 36B in the projection direction thereof may be greater than the length D32 of each of the first to fourth projections Q1 to Q4 in the projection direction thereof (D31>D32), the disclosure is not limited thereto. In another embodiment, the former may be less than or equal to the latter.

Referring to FIG. 14, each of the projections Q1 to Q4 of the barrel unit 110 may be disposed or fitted into a corresponding one of the grooves B1 to B4 in the lens holder 140.

The projections Q1 to Q4 of the barrel unit 110 are capable of limiting or inhibiting rotation of the barrel unit 110, or of inhibiting rotation of the barrel unit 110 beyond a predetermined angle, during assembly of the barrel unit 110 with the lens holder 140. In other words, the projections Q1 to Q4 may be anti-rotation projections for limiting or inhibiting rotation of the barrel unit 110, and the grooves in the lens holder 140 may be “guide portions” for guiding the projections Q1 to A4.

If the projections Q1 to Q4 of the barrel unit 110 and the grooves B1 to B4 in the lens holder 140 according to the embodiment are not provided, the barrel unit may be rotated and thus may project outwards from the lens holder during assembly of the barrel unit with the lens holder, and there may be a collision between the cover and the barrel unit and deformation of the barrel unit and/or the cover during assembly of the cover with the lens holder. The embodiment is capable of inhibiting collision of the barrel unit with the cover and thus of inhibiting deformation and damage to the lens barrel and/or the cover.

FIG. 15A is a perspective view of a barrel unit 110-1 according to another embodiment. FIG. 15B is a plan view of FIG. 15A. In these drawings, the same reference numerals as those in FIGS. 10 to 11C denote the same parts, and a description of the same parts is given briefly or omitted.

Referring to FIGS. 15A and 15B, the barrel unit 110-1 may include a first surface 101A, a second surface 102, which is disposed opposite the first surface 101A, side surfaces 103a to 103d, which connect the first surface 101A to the second surface 102, and openings 505A and 505B, which are formed in the side surfaces 103a to 103d and in which at least a portion of the liquid lens unit 130 is disposed. Although reference numerals “103d” and “505B” shown in FIG. 15A are not described, the description of reference numerals “103d” and “550B” may be applied with or without modification.

The barrel unit 110-1 may include an upper surface 101A, which is connected to the side surfaces 103a to 103d and is stepped. The upper surface 101A of the barrel unit 110-1 may include a first region P11 and a second region P12, which has a height difference with respect to the first region P11 in the optical-axis direction. Furthermore, the upper surface 101A of the barrel unit 110-1 may include a third region P13 connecting the first region P11 to the second region P12.

For example, the upper surface 101A of the barrel unit 110-1 may include a stepped portion, which includes the first region P11, and the second region P12, which has a height difference with respect to the first region P11.

The stepped portion of the barrel unit 110-1 may include a first stepped portion 610 and a second stepped portion 620, which are formed between the third side surface 103c and the fourth side surface 103d of the barrel unit 110-1, and a third stepped portion 630 and a fourth stepped portion 640, which are formed between the first side surface 103a and the second side surface 103b of the barrel unit 110-1.

For example, the first stepped portion 610 may be formed between the second body 8B and the third side surface 103c of the barrel unit 110-1 so as to be parallel to the third side surface 103c.

For example, the second stepped portion 620 may be formed between the second body 8B and the fourth side surface 103c of the barrel unit 110-1 so as to be parallel to the fourth side surface 103d.

For example, the third stepped portion 630 may be formed between the second body 8B and the first side surface 103a so as to be parallel to the first side surface 103a.

For example, the fourth stepped portion 640 may be formed between the second body 8B and the second side surface 103b of the barrel unit 110-1 so as to be parallel to the second side surface 103b.

For example, the first stepped portion 610 may be connected at one end thereof to one end of the third stepped portion 630 and at the other end thereof to one end of the fourth stepped portion 640. Each of the first corner portion between the one end of the first stepped portion 610 and the one end of the third stepped portion 630 and the second corner portion between the other end of the first stepped portion 610 and the one end of the fourth stepped portion 640 may have a rounded shape or a curved shape.

For example, the second stepped portion 620 may be connected at one end thereof to the other end of the third stepped portion 630 and at the other end thereof to the other end of the fourth stepped portion 640. Each of the third corner portion between the one end of the second stepped portion 620 and the other end of the third stepped portion 630 and the fourth corner portion between the other end of the second stepped portion 620 and the other end of the fourth stepped portion 640 may have a rounded shape or a curved shape.

For example, the barrel unit 110-1 may include a first barrel portion 110A, a second barrel portion 110B1, and a third barrel portion 110C. The second barrel portion 110B1 shown in FIG. 15A has a shape different from the shape of the second barrel portion 110B shown in FIG. 10.

The second barrel portion 110B1 may include a first body 8A1 disposed on the first barrel portion 110A and a second body 8B disposed on the first body 8A1.

The second body 8B may project from the upper portion of the first body 8A1. For example, the second body 8B may project from the upper portion of the first body 8A1 in the optical-axis direction or in an upward direction.

The upper surface of the first body 8A1 may include a stepped portion, which includes a first region P11, and a second region P12, which has a height difference with respect to the first region P11 in the optical-axis direction.

For example, the upper surface of the first body 8A1 may further include a third region P13 connecting the first region P11 to the second region P12. For example, the stepped portion of the first body 8A1 may include the first region P11, the second region P12, and the third region P13.

The second region P12 of the upper surface of the first body 8A1 may abut on the lower portion or the lower end of the second body 8B, and the first region P11 of the upper surface of the first body 8A1 may abut on the upper portions or the upper ends of the side surfaces 53a to 53d of the first body 8A1.

Although the second region P12 of the first body 8A1 may be formed around the lower portion or the lower end of the second body 8B so as to surround the lower portion or the lower end of the second body 8B, the disclosure is not limited thereto.

For example, the stepped portion of the first body 8A1 may be configured so as to surround the second body 8B of the second barrel portion 110B.

For example, the stepped portion of the first body 8A1 may include the first stepped portion 610, parallel to the third side surface 53c of the first barrel portion 110A, the second stepped portion 620, parallel to the fourth side surface 52d of the first barrel portion 110A, the third stepped portion 630, parallel to the first side surface 52a of the first barrel portion 110A, and the fourth stepped portion 640, parallel to the second side surface 52b of the first barrel portion 110A.

At least a portion of the periphery of the second region P12 of the barrel unit 110-1 or at least a portion of the third region P13 may be spaced apart from the lower portion (or the lower end) of the second body 8B.

For example, the periphery of the second region P12 of the barrel unit 110-1 of the stepped portions 610 to 640 may be spaced apart from the boundary line (or the boundary region) 501 between the lower portion (or the lower end) of the second body 8B and the second region P12.

For example, the shortest distance d11 between the boundary line 501 and the periphery of the second region P12 of the first stepped portion 610 (or the boundary line between the second region and the third region) may be equal to the shortest distance d12 between the boundary line 501 and the periphery of the second region P12 of the second stepped portion 620 (or the boundary line between the second region and the third region) (d11=d12).

For example, the shortest distance d13 between the boundary line 501 and the periphery of the second region P12 of the third stepped portion 630 (or the boundary line between the second region and the third region) may be equal to the shortest distance d14 between the boundary line 501 and the periphery of the second region P12 of the fourth stepped portion 640 (or the boundary line between the second region and the third region) (d13=d14).

For example, each of d11 and d12 may be greater than each of d13 and d14.

The first region P11 of the upper surface of the first body 8A1 may be formed around the second region P12 so as to surround the second region P12 of the upper surface of the first body 8A1.

For example, the first width or the first length of the first region P11 of the first and second stepped portions 610 and 620 in a direction perpendicular to the third side surface 103c of the barrel unit 110-1 may be less than the second width or the second length of the first region P11 of the first and second stepped portions 610 and 620 in a direction perpendicular to the first side surface 103a of the barrel unit 110-1.

For example, the third width or the third length of the first region P11 of the third and fourth stepped portions 630 and 640 in a direction perpendicular to the first side surface 103a of the barrel unit 110-1 may be less than the fourth width or the fourth length of the first region P11 of the third and fourth stepped portions 630 and 640 in a direction perpendicular to the third side surface 103C of the barrel unit 110-1.

For example, the first width or the first length of the first region P11 of the first and second stepped portions 610 and 620 may be greater than the third width or the third length of the first region P11 of the third and fourth stepped portions 630 and 640.

For example, although the second width or the second length of the first region P11 of the first and second stepped portions 610 and 620 may be less than the fourth width or the fourth length of the first region P11 of the third and fourth stepped portions 630 and 640, the disclosure is not limited thereto. In another embodiment, the former may be greater than or equal to the latter.

In order to stabilize the performance of a liquid lens, which is included in a camera module mounted on the front surface of a mobile device, for example, a cellular phone, the size of the liquid lens may be increased. When the size of the liquid lens is increased for this reason, the size of a holder, in which the liquid lens is seated, may also be increased, and the size of the reception space in a barrel unit, in which the holder is fitted or mounted, may also be increased.

However, when only the size of the reception space is increased without increasing the size of the barrel unit due to restrictions on the size of the camera module mounted on the front surface of the cellular phone, the thickness of a portion of the barrel unit, for example, a second lens unit may be decreased, and thus the strength of the barrel unit may be decreased. When the strength of the barrel unit is decreased, the barrel unit may undergo deformation or damage caused by external force during assembly of the barrel unit with the lens assembly and assembly of the barrel unit with the lens holder, thereby deteriorating the performance and the reliability of the camera module.

The embodiments are capable of increasing the strength of the barrel unit 110 without increasing the size of the camera module by forming the stepped portions 510 or 510-1 at the barrel unit 110, thereby inhibiting deformation of the barrel unit caused by application of external force during an assembly process and inhibiting deterioration of the reliability of the camera module.

The camera module 100 according to the embodiment may be included in an optical instrument, which is designed to form the image of an object in a space using reflection, refraction, absorption, interference, diffraction or the like, which are characteristics of light, to extend eyesight, to record an image obtained through a lens or to reproduce the image, to perform optical measurement, or to propagate or transmit an image.

For example, although the optical instrument according to the embodiment may be a mobile phone, cellular phone, smart phone, portable smart instrument, digital camera, laptop computer, digital broadcasting terminal, PDA (Personal Digital Assistant), PMP (Portable Multimedia Player), navigation device, or the like, the disclosure is not limited thereto. Furthermore, any device capable of taking images or photographs is possible.

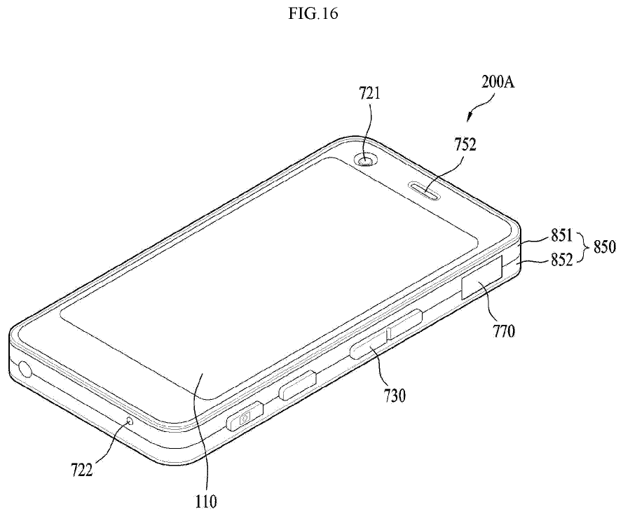

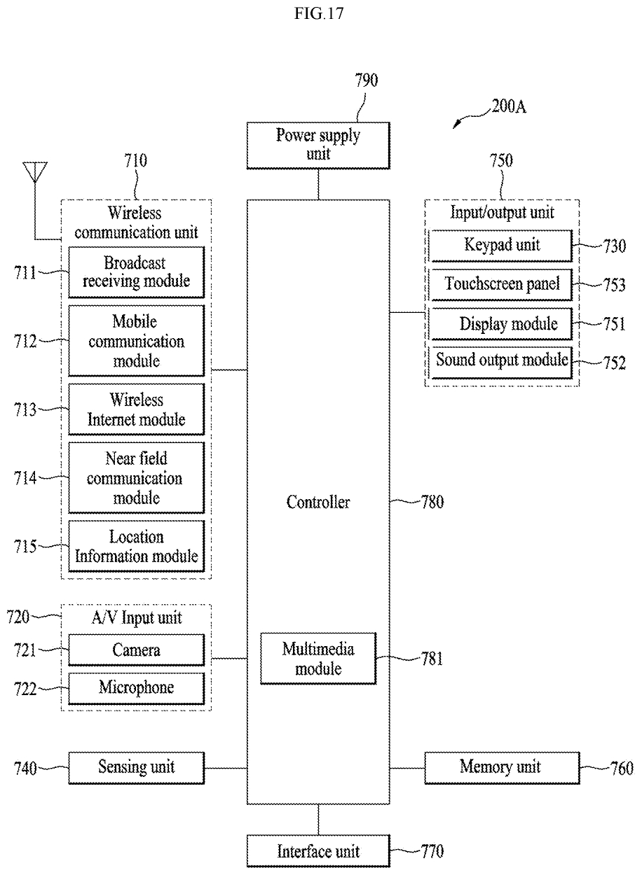

FIG. 16 is a perspective view illustrating a portable terminal 200A according to an embodiment. FIG. 17 is a view illustrating the configuration of the portable terminal 200A illustrated in FIG. 16.

Referring to FIGS. 16 and 17, the portable terminal (hereinafter, referred to as a “terminal”) 200A may include a body 850, a wireless communication unit 710, an audio/video (A/V) input unit 720, a sensing unit 740, an input/output unit 750, a memory unit 760, an interface unit 770, a controller 780, and a power supply unit 790.

The body 850 illustrated in FIG. 16 has a bar shape, without being limited thereto, and may be any of various types, such as, for example, a slide type, a folder type, a swing type, or a swivel type, in which two or more sub-bodies are coupled so as to be movable relative to each other.

The body 850 may include a case (a casing, housing, cover or the like) defining the external appearance of the terminal. For example, the body 850 may be divided into a front case 851 and a rear case 852. Various electronic components of the terminal may be accommodated in the space defined between the front case 851 and the rear case 852.

The wireless communication unit 710 may include one or more modules, which enable wireless communication between the terminal 200A and a wireless communication system or between the terminal 200A and a network in which the terminal 200A is located. For example, the wireless communication unit 710 may include a broadcast-receiving module 711, a mobile communication module 712, a wireless Internet module 713, a nearfield communication module 714, and a location information module 715.

The A/V input unit 720 serves to input audio signals or video signals, and may include, for example, a camera 721 and a microphone 722.

The camera 721 may include the camera module 100.

The sensing unit 740 may sense the current state of the terminal 200A, such as, for example, the opening or closing of the terminal 200A, the location of the terminal 200A, the presence of a user's touch, the orientation of the terminal 200A, or the acceleration/deceleration of the terminal 200A, and may generate a sensing signal to control the operation of the terminal 200A. When the terminal 200A is, for example, a slide-type cellular phone, the sensing unit 740 may sense whether the slide-type cellular phone is opened or closed. Furthermore, the sensing unit 740 may sense the supply of power from the power supply unit 790, coupling of the interface unit 770 to an external device, and the like.

The input/output unit 750 serves to generate, for example, visual, audible, or tactile input or output. The input/output unit 750 may generate input data to control the operation of the terminal 200A, and may display information processed in the terminal 200A.

The input/output unit 750 may include a keypad unit 730, a display module 751, a sound output module 752, and a touchscreen panel 753. The keypad unit 730 may generate input data in response to input on a keypad.

The display module 751 may include a plurality of pixels, the color of which varies depending on the electrical signals applied thereto. For example, the display module 751 may include at least one among a liquid crystal display, a thin-film transistor liquid crystal display, an organic light-emitting diode, a flexible display and a 3D display.

The sound output module 752 may output audio data received from the wireless communication unit 710 in, for example, a call-signal reception mode, a call mode, a recording mode, a voice recognition mode, or a broadcast reception mode, or may output audio data stored in the memory unit 760.

The touchscreen panel 753 may convert variation in capacitance, caused by a user's touch on a specific region of a touchscreen, into electrical input signals.

The memory unit 760 may temporarily store programs for the processing and control of the controller 780, and input/output data (for example, telephone numbers, messages, audio data, stationary images, moving images and the like). For example, the memory unit 760 may store images captured by the camera 721, for example, pictures or moving images.

The interface unit 770 serves as a path through which the lens moving apparatus is connected to an external device connected to the terminal 200A. The interface unit 770 may receive power or data from the external component, and may transmit the same to respective constituent elements inside the terminal 200A, or may transmit data inside the terminal 200A to the external component. For example, the interface unit 770 may include a wired/wireless headset port, an external charger port, a wired/wireless data port, a memory card port, a port for connection to a device equipped with an identification module, an audio input/output (I/O) port, a video input/output (I/O) port, an earphone port and the like.

The controller 780 may control the general operation of the terminal 200A. For example, the controller 780 may perform control and processing related to, for example, voice calls, data communication, and video calls.

The controller 780 may include a multimedia module 781 for multimedia playback. The multimedia module 781 may be embodied in the controller 780, or may be embodied separately from the controller 780.

The controller 780 may perform a pattern recognition process capable of recognizing writing input or drawing input carried out on a touch screen as a character and an image, respectively.

The power supply unit 790 may supply power required to operate the respective constituent elements upon receiving external power or internal power under the control of the controller 780.

The features, configurations, effects and the like described above in the embodiments are included in at least one embodiment, but the invention is not limited only to the embodiments. In addition, the features, configurations, effects and the like exemplified in the respective embodiments may be combined with other embodiments or modified by those skilled in the art. Accordingly, content related to these combinations and modifications should be construed as falling within the scope of the disclosure.

### INDUSTRIAL APPLICABILITY

The embodiments are applicable to a lens barrel, and a camera module and an optical device each including the lens barrel, which are capable of allowing a large-sized liquid lens to be mounted thereon and of increasing the strength of the barrel unit without increasing the length thereof in the optical-axis direction.

1. A lens barrel comprising:
a barrel unit including a first surface, a second surface disposed opposite the first surface, a side surface connecting the first surface to the second surface, and an opening, which is formed in the side surface and in which at least a portion of a variable lens is disposed;
a first lens unit, which is disposed at the barrel unit and at one side of the variable lens; and
a second lens unit, which is disposed at the barrel unit and at another side of the variable lens,
wherein the first surface of the barrel unit includes a first region and a second region having a portion that is a stepped portion with respect to the first region, and
wherein the stepped portion is positioned above the opening of the barrel unit.

2. The lens barrel according to claim 1, wherein the first region of the first surface is connected to the side surface of the barrel unit, and the second region of the first surface is positioned higher than the first region.

3. The lens barrel according to claim 2, wherein the barrel unit includes a first portion, at which the first lens unit is disposed and which projects from the second region of the barrel unit.

4. The lens barrel according to claim 3, wherein the barrel unit includes a second portion, at which the second lens unit is disposed and which projects from the second surface of the barrel unit.

5. The lens barrel according to claim 1, wherein the side surface of the barrel unit includes a first side surface and a second side surface, which face each other, and the opening has a first opening formed in the first side surface, and a second opening formed in the second side surface.

6. The lens barrel according to claim 5, wherein the side surface of the barrel unit includes a third side surface and a fourth side surface, which connect the first side surface to the second side surface and face each other, and the stepped portion includes a first stepped portion and a second stepped portion, which are formed between the third side surface and the fourth side surface.

7. The lens barrel according to claim 6, wherein the stepped portion includes a third stepped portion and a fourth stepped portion, which are formed between the first side surface and the second side surface and connect the first stepped portion to the second stepped portion.

8. The lens barrel according to claim 6, wherein the first region of the barrel unit is connected both to the third side surface and to the fourth side surface.

9. The lens barrel according to claim 6, wherein the first stepped portion is parallel to the third side surface of the barrel unit, and the second stepped portion is parallel to the fourth side surface of the barrel unit.

10. The lens barrel according to claim 6, wherein the barrel unit includes a projection projecting from at least one of the first side surface and the second side surface.

11. The lens barrel according to claim 7, wherein a width of the first region in a direction perpendicular to the third side surface is less than a width of the first region in a direction perpendicular to the first side surface.

12. The lens barrel according to claim 10, wherein an upper end of the projection is positioned higher than the opening in the barrel unit.

13. The lens barrel according to claim 12, wherein a lower end of the projection is positioned lower than the opening in the barrel unit.

14. The lens barrel according to claim 1, wherein the variable lens comprises a liquid lens.

15. A camera module comprising:
a circuit board;
a lens holder disposed on the circuit board;
a lens barrel coupled to the lens holder;
a lens assembly disposed in the lens barrel and comprising a first lens unit and a second lens unit, and a variable lens disposed between the first lens unit and the second lens unit,
wherein the lens barrel comprises a side surface comprising an opening in which at least a portion of the variable lens is disposed and a projection formed at one side of the opening, and
wherein the lens holder has a groove in which the projection of the lens barrel is disposed.

16. The lens barrel according to claim 15, wherein the lens barrel comprises an upper surface connected to the side surface and comprising a stepped portion, and
wherein the stepped portion comprises a first region and a second region having a height difference in the optical-axis direction with respect to the first region.

17. The lens barrel according to claim 15, wherein the lens holder comprises a column formed at a corner thereof, and the groove in the lens holder is formed in the column.

18. The lens barrel according to claim 15, wherein the variable lens comprises a liquid lens.

19. The lens barrel according to claim 16, comprising a cover configured to receive the lens holder, wherein the cover comprises a top plate, a side plate extending from the top plate, and a bore formed in the top plate, and
wherein a spatial interference between the stepped portion and the cover is avoided by virtue of the bore of the cover.

20. A camera module comprising:
a circuit board;
a lens holder disposed on the circuit board; and
a lens barrel coupled to the lens holder,
wherein the lens barrel comprises:
a barrel unit including a first surface, a second surface disposed opposite the first surface, a side surface connecting the first surface to the second surface, and an opening, which is formed in the side surface and in which at least a portion of a variable lens is disposed;
a first lens unit, which is disposed at the barrel unit and at one side of the variable lens; and
a second lens unit, which is disposed at the barrel unit and at another side of the variable lens,
wherein the first surface of the barrel unit includes a first region and a second region having a portion that is stepped portion with respect to the first region, and
wherein the stepped portion is positioned above the opening of the barrel unit.
